(19) United States
(12) Patent Application Publication
(10) Pub. No.: US 2022/0207872 A1
(43) Pub. Date: Jun. 30, 2022

(54) APPARATUS AND METHOD FOR PROCESSING PROMPT INFORMATION

(71) Applicant: Samsung Electronics Co., Ltd., Suwon-si, Gyeonggi-do (KR)

(72) Inventors: Taorui REN, Beijing (CN); Yifei GUO, Beijing (CN)

(21) Appl. No.: 17/594,484

(22) PCT Filed: Apr. 20, 2020
(86) PCT No.: PCT/KR2020/005217

§ 371 Date: Oct. 18, 2021

(30) Foreign Application Priority Data
Apr. 19, 2019 (CN) 201910320193.1

(51) Int. Cl. G06V 20/20; G10L 15/22; G06F 3/16; G06T 19/00; G06V 10/22; G06V 20/70

(52) U.S. Cl. CPC G06V 20/20; G10L 15/22; G06V 20/70; G06T 19/006; G06V 10/235; G06F 3/167

(57) ABSTRACT

A prompt information processing apparatus and method are provided. The apparatus may include a memory configured to store one or more instructions, and at least one processor configured to execute the one or more instructions stored in the memory to: obtain prompt information, and obtain an object to output the prompt information based on the object.

### CROSS-REFERENCE TO RELATED APPLICATIONS

This application is a 371 National Stage of International Application No. PCT/KR2020/005217, filed Apr. 20, 2020, which claims priority to Chinese Patent Application No. 201910320193.1, filed Apr. 19, 2019, the disclosures of which are herein incorporated by reference in their entirety.

### BACKGROUND

### 1. Field

The present disclosure relates to the field of computer technology, and in particular, to a prompt information processing method, apparatus, electronic device and readable storage medium.

### 2. Description of Related Art

In the current era of information explosion, there is a need to record a lot of fragmented information in daily work and life, including reminder content, time, place, character and the like. Users often record the fragmented information on a notebook or on electronic devices such as a mobile phone or tablet. When the reminder time arrives, the electronic device will push the corresponding reminders to the user.

However, the establishment of the current reminder items needs to be completed by the user initiatively. The user needs to give a clear instruction to establish the reminder item, and the electronic device establishes the reminder item based on the user's instruction. In addition, when the user establishes the reminder item by initiating a voice instruction, there may be problems such as establish inaccurate reminder items or failure to establish reminder items due to various reasons (such as limited user speech input, insufficient standard words, etc.). Therefore, for the implementation of the current reminder items, the user experience is poor, which may not satisfy actual application requirements of the user.

### SUMMARY

A prompt information processing apparatus and method are provided. The apparatus may include a memory configured to store one or more instructions, and at least one processor configured to execute the one or more instructions stored in the memory to: obtain prompt information, and obtain an object to output the prompt information based on the object.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic flowchart diagram illustrating a prompt information processing method provided by an embodiment of the present disclosure;

FIG. 2 illustrates a schematic structural diagram of a prompt information processing system provided by an embodiment of the present disclosure;

FIG. 3 illustrates a schematic structural diagram of an image recognition module provided by an embodiment of the present disclosure;

FIG. 4 illustrates a schematic diagram showing the operation principle of performing image recognition by an image recognition module provided by an embodiment of the present disclosure;

FIG. 5 illustrates a schematic structural diagram of an automatic speech recognition and natural language understanding module provided by an embodiment of the present disclosure;

FIG. 6 illustrates a schematic structural diagram of an image recognition output storage and analysis module and a speech understanding output storage and analysis module provided by an embodiment of the present disclosure;

FIG. 7A illustrates a schematic diagram of a user view image provided by an embodiment of the present disclosure;

FIG. 7B illustrates a schematic diagram of an object recognition result of the user view image in FIG. 7A in Example 1;

FIG. 7C illustrates a schematic diagram of the display of the prompt information in Example 1;

FIG. 7D illustrates a schematic diagram of an object recognition result of the user view image in FIG. 7A in Example 2 of the present disclosure;

FIG. 7E illustrates a schematic diagram of the display of the prompt information in Example 2;

FIG. 8 illustrates a schematic diagram of the operation principle of selecting an object according to user preferences provided by Example 3 of the present disclosure;

FIG. 9 illustrates a schematic structural diagram of a prompt information processing system provided in Example 4 of the present disclosure;

FIG. 10 illustrates a schematic diagram of the display of the prompt information in Example 4 of the present disclosure;

FIG. 11A illustrates a schematic diagram of an application scene provided in Example 5 of the present disclosure;

FIG. 11B illustrates a schematic diagram of the display of the prompt information in Example 5;

FIG. 12 illustrates a schematic structural diagram of a prompt information processing system provided in Example 5 of the present disclosure;

FIG. 13A illustrates a schematic diagram of an application scene provided in Example 6 of the present disclosure;

FIG. 13B illustrates a schematic diagram of the display of the prompt information in Example 6;

FIG. 14 illustrates a schematic diagram of the operation principle of a prompt information processing method provided in Example 7 of the present disclosure;

FIG. 15A illustrates a schematic diagram of the display of the prompt information in Example 8 of the present disclosure;

FIG. 15B illustrates a schematic diagram of a scene in which the object that is moved in Example 8;

FIG. 15C illustrates another schematic diagram of the display of the prompt information in Example 8;

FIG. 16 illustrates a schematic structural diagram of an image recognition module provided in Example 9 of the present disclosure;

FIG. 17 illustrates a schematic structural diagram of a prompt information processing system provided in Example 9 of the present disclosure;

FIG. 18A illustrates a schematic diagram of a user view image provided in Example 10 of the present disclosure;

FIG. 18B illustrates a schematic diagram of the user editing the image in Example 10;

FIG. 18C illustrates a schematic diagram of the display of the prompt information in Example 10;

FIG. 19 illustrates a schematic diagram of the operation principle of a prompt information processing method in Example 10;

FIG. 20A illustrates a schematic diagram of an application scene in Example 11 of the present disclosure;

FIG. 20B illustrates a schematic diagram of the user editing the image in Example 11;

FIG. 20C illustrates a schematic diagram of the display of the prompt information in Example 11;

FIG. 21 illustrates a schematic structural diagram of a prompt information processing apparatus provided by an embodiment of the present disclosure; and

FIG. 22 illustrates a schematic structural diagram of an electronic device provided by an embodiment of the present disclosure.

### DETAILED DESCRIPTION

The purpose of the embodiments of the present application aims to solve at least one of the existing technical defects. The solutions provided by embodiments of the present application are as follows:

In a first aspect, the embodiment of the present disclosure provides a prompt information processing method, wherein the method includes: obtaining prompt information; obtaining an object in a user view image to output prompt information based on the object.

In a second aspect, the embodiment of the present disclosure provides a prompt information processing apparatus, wherein the apparatus includes: a prompt information obtaining module, configured to obtain prompt information; an object obtaining module, configured to obtain an object in a user view image to output the prompt information based on the object.

In a third aspect, the embodiment of the present disclosure provides an electronic device, wherein the electronic device includes a processor and a memory; the memory stores machine readable instructions; the processor is configured to execute the machine readable instructions to implement the method provided by the embodiment of the present disclosure.

Optionally, the electronic device includes an Augmented Reality (AR) device or a Virtual Reality (VR) device.

In a fourth aspect, the embodiment of the present disclosure provides a computer readable storage medium, wherein the readable storage medium stores a computer program, the computer program being executed by a processor to implement the method provided by the embodiment of the present disclosure.

Embodiments of the present disclosure provide methods and apparatuses for processing prompt information.

In one embodiment, a prompt information processing apparatus may include a memory configured to store one or more instructions, and at least one processor configured to execute the one or more instructions stored in the memory to: obtain prompt information, and obtain an object to output the prompt information based on the object.

In one embodiment, the prompt information and the object are obtained by: obtaining and analyzing a user voice instruction, obtaining and analyzing a user view image, and determining the prompt information and the object based on a result of the user voice instruction analysis and a result of the user view image analysis.

In one embodiment, the at least one processor is further configured to: determine an image analysis algorithm based on the user voice instruction, and analyze the user view image based on the determined image analysis algorithm.

In one embodiment, the at least one processor is further configured to: analyze the user voice instruction based on a preliminary result of the user view image analysis, and analyze the user view image based on a preliminary result of the user voice instruction analysis.

In one embodiment, the object are obtained by: determining a plurality of selectable object options for the prompt information based on the result of the user voice instruction analysis and the result of the user view image analysis; and obtaining the object based on user's choice from the plurality of selectable object options.

In one embodiment, the object are obtained by: determining the object in the user view image based on object indication information carried in the user voice.

In one embodiment, the object are obtained by: obtaining and analyzing a user voice instruction, determining the prompt information based on a result of the user voice instruction analysis, determining whether object indication information is carried in the user voice instruction, and on determining that the object indication information is not carried in the user voice instruction, automatically determining the object based on the result of the user voice instruction analysis.

In one embodiment, the at least one processor is further configured to: when position information of the object changes, displaying the prompt information in a user view image according to the changed position information of the object.

In one embodiment, the prompt information and the object are obtained by: obtaining a historical image of a user, recognizing a user behavior based on the historical image, and automatically generating the prompt information according to the user behavior.

In one embodiment, the prompt information and the object are obtained by: obtaining a photo, displaying the photo, obtaining user input associated with the displayed photo, and determining the prompt information and the object by analyzing the user input associated with the displayed photo.

In one embodiment, the prompt information is obtained by receiving the prompt information from another device, and the at least one processor is further configured to display the prompt information in a user view image based on the object.

In one embodiment, the object are obtained by: obtaining information sent by the other device that can be used for determining the object, and determining the object in the user view image based on the received information that can be used for determining the object.

In one embodiment, the prompt information is obtained by receiving the prompt information from another device, and the at least one processor is further configured to display the prompt information in a photo based on the mapping relationship between the photo and a user view image.

In another embodiment, a prompt information processing method is provided. The method may include: obtaining prompt information, and obtaining an object to output the prompt information based on the object.

The beneficial effects brought by the technical solutions provided by the present disclosure are: the prompt information processing method provided by the embodiment of the present disclosure may display the prompt information to a user according to the object determined by performing image recognition on the user view image, realizing diversified display of the prompt information compared with existing prompt information processing methods, thereby improving user experience and better satisfying user requirement.

Embodiments of the present disclosure will be described in detail hereafter. The examples of these embodiments have been illustrated in the drawings throughout which same or similar reference numerals refer to same or similar elements or elements having same or similar functions. The embodiments described hereafter with reference to the drawings are illustrative, merely used for explaining the present disclosure and should not be regarded as any limitations thereto.

It should be understood by those skill in the art that singular forms “a”, “an”, “the”, and “said” may be intended to include plural forms as well, unless otherwise stated. It should be further understood that terms “include/including” used in this specification specify the presence of the stated features, integers, steps, operations, elements and/or components, but not exclusive of the presence or addition of one or more other features, integers, steps, operations, elements, components, and/or combinations thereof. It should be understood that when a component is referred to as being “connected to” or “coupled to” another component, it may be directly connected or coupled to other elements or provided with intervening elements therebetween. In addition, “connected to” or “coupled to” as used herein may include wireless connection or coupling. As used herein, term “and/or” includes all or any of one or more associated listed items or combinations thereof.

The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

In order to better illustrate the solutions provided by the embodiments of the present disclosure, the relevant technologies related to the present disclosure are first described in the following.

With the development of artificial intelligence, the way of recording information on electronic devices has evolved from the original manual inputting information to input information controlled by voice, which provides a lot of convenience for our lives. At present, most electronic devices (such as mobile phones, tablet computers, etc.) have pre-installed means of reminder items for users, and the reminder items generally support the following functions:

1. set or edit reminder content;

2. set specific reminder time or periodic reminder time;

3. set priority of a reminder item;

4. set the category attribute of the reminder item, and modify the category to which it belongs according to the completion condition of the reminder item. For example, there are several reminder items in an unfinished category, after which the user may set the completed content to the completed category;

5. add additional notes;

6. set a position where the reminder item triggers to reminder;

7. set the character information associated with the reminder item, such as mobile phone number, geographic position, etc.; and

8. delete a reminder item that has been established.

The reminder items established by a voice assistant may be classified into the following different situations:

1. the purpose and content of the reminder item is clearly said at one time. For example, the user said to the voice assistant “establish a reminder item for the meeting at 8:00 tomorrow morning”, and the system will establish a reminder item of which the content is “meeting” for the user and set the time to 8:00 am the next morning.

2. the purpose and content of the reminder item are respectively interpreted. For example, the user says “establish a reminder item” to the voice assistant. The voice assistant will ask “OK, please tell the content to be reminded” and wait for the user's next instruction, then the user again input the reminder content “meeting at 8:00 am tomorrow”, and the voice assistant will generate a reminder content that the content is “meeting” for the next day at 8:00 am.

There are a variety of technologies for supporting adding reminder items by the voice, which may specifically include:

1. the user's voice information is converted into text information by using automatic speech recognition (ASR);

2. the text is analyzed through the Natural language understanding tools (NLU) and reminder item operations are set according to the user's requirement;

3. the voice assistant uses a text to speech (TTS) tool to play confirmation information.

In addition, with the development of artificial intelligence, AR/VR devices have also become popular, enabling people to create various virtual objects in AR/VR scenes, and since AR/VR devices may provide the user with contents that are richer and closer to the real world, consequently, if the function of the reminder item may be realized by AR/VR devices, the user may be provided with some personalized reminder service more intuitively.

It should be noted that the AR/VR devices described in embodiments of the present disclosure are a generic concept, and may be a dedicated device designed for an AR/VR scene, or may another device supporting AR/VR functions, for example, mobile phones or tablets with the AR function, which are generally referred to as AR/VR devices in the embodiment of the present disclosure.

When the prompt information is displayed by using a device such as the AR/VR devices, the object (i.e., an article) on which the virtual reminder tag of the prompt information may be displayed may include, but is not limited to:

1. static virtual objects such as notes and drawings;

2. virtual objects such as albums and books that may be used to interact;

3. virtual objects such as televisions and tablets that may present multimedia information;

4. virtual objects with autonomous motion attributes such as animals and characters.

From a technical point of view, the AR device needs to model the real scene, and the VR device already has a model of the virtual scene, and then the virtual reminder tag is placed in the already established scene model. The case where the user interacts with the virtual object in the scene by using the AR/VR device may include, but is not limited to:

1. calculate the viewing angle and the position of the AR/VR device in the scene by means of sensors such as the gyroscope and camera of the device;

2. the AR/VR device generates a virtual object in a 3 Dimensions (3D) space, and renders a projected image of the virtual object in the user's eyes according to the user's perspective state, and then displays it to the user;

3. real-time interaction is performed with virtual objects through remote control operations, gesture recognition, speech recognition and other technologies.

The virtual reminder tag in the AR/VR scene may be assigned to an object, that is, other information in the scene are required to locate the virtual reminder tag. For example, a virtual reminder tag is generated for a real object in the scene, and since the tag is rich in form, the user may see a virtual note, an album, a video player, and the like.

Although the existing item reminding function may satisfy most of the user's work and life requirements, the inventors of the present disclosure finds that the existing item reminding function still has one or more of the following problems to be improved:

1. the reminder items set by electronic devices such as mobile phones have limited ways of displaying information to users, generally includes: directly displaying text information to users through a screen or broadcasting information through a voice assistant;

2. reminders related to real-time scenes only use textual expressions that requires a lot of statements to describe the scene, and this operation is complicated, and is not concise or intuitive;

3. the image recognition algorithm is independent of the operation of automatic speech recognition and natural language understanding module, and in order to obtain more information, it is necessary to invoke many algorithm modules to calculate the object attributes in the scene at the same time, where the calculation amount is large and the resource consumption is large;

4. automatic speech recognition and natural language understanding are also independent of the image recognition module, and speech recognition and language understanding fully use the voice information input by the user, and then the most likely result is selected as the output, where the system cannot give an output that most satisfies the user intent in combination with the scene;

5. the user population in daily life is very wide, in which everyone has its own habits; for a voice instruction deviating standards, such as non-standard Mandarin with local dialect features, or some users use another appellation for objects or events as personal reasons or geographical reasons, where although it may be improved by increasing the training library, but it cannot be fully considered the special habits of each user;

6. the existing system cannot automatically determine the user's behavior intent since the input information is limited, so the system cannot automatically establish a reminder item for the user according to the user's possible requirements;

7. the existing action recognition algorithm may calculate simple actions of the user, but the algorithm is often based on some simple rules, and cannot associate the object in the scene with the attribute information of the object, of which the output is simple and the accuracy is low;

8. the existing action recognition algorithm may only perform recognition on predefined actions, and cannot perform customized processing according to the user's personal habits;

9. in order to create a virtual object in the scene, the existing AR/VR system needs to locate the position of the virtual object according to the object in the scene, and the position of the virtual object depends on the fixed scene, which cannot satisfy the requirement that the user uses the same tag for a class of objects in different scenes;

10. in the existing AR/VR system, when an object is moved, its attached tag cannot be effectively tracked and recorded;

11. in the existing AR/VR system, when a tag needs to be added into one of a plurality of similar or identical objects in the scene, the system cannot select one of them according to the user's preference if the user instruction is not very clear; and

12. the existing AR/VR system interacts by voice or remote control and lacks interaction with other electronic devices such as mobile phones and tablets.

In order to solve at least one technical problem in the prior art, the embodiments of the present disclosure provide a prompt information processing method, apparatus, electronic device, and readable storage medium. The following provides a detailed description of the solution provided by the embodiments of the present disclosure.

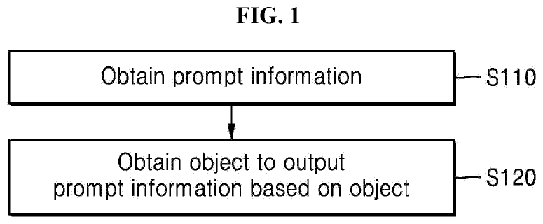

FIG. 1 illustrates a schematic flowchart diagram of the prompt information processing method provided by the embodiment of the present disclosure, and as shown in FIG. 1, the method may include the following steps:

Step S110: obtaining prompt information;

Step S120: obtaining an object in a user view image to output the prompt information based on the object.

The object can be determined by performing image recognition on the user view image.

It may be understood that the user view image is an image that is located within the user's view. The image may be an obtained image in the user's view, and may be one or more frame of images in the video streams of the obtained range of user's current view. In addition, when the scene seen by the user is a real scene, the user view image is a real image of the user's current view. When the scene seen by the user is a virtual scene, the user view image is an image in the virtual scene seen by the user.

In an alternative embodiment of the present disclosure, the object may be determined by at least one of the following manners:

determining by performing image recognition on the user view image;

determining according to the object data in the user view image.

Wherein, for the real view image or the virtual view image, the manner of performing recognition on the view image may be both used to obtain the required base object when the prompt information is displayed. If the scene seen by the user view is a virtual scene (that is, a VR scene), the data (including the position in the virtual scene) of each object in the scene is fixed in the scene, and therefore, in the VR scene, it may also determine the object in the virtual image of the user's view based on the digital information (including the position information) that builds the virtual object.

The method provided by the embodiment of the present disclosure may output the prompt information based on the object in the user view image, so that the prompt information may be displayed on the object in the user's view through the AR/VR device. Based on this solution, the user is provided with more diversified prompting implementations, which may display the reminder content closer to the real world for the user, enhance the user perception, and better satisfy the actual application requirements of the user.

In an alternative embodiment of the present disclosure, the prompt information may be obtained by at least one of the following manners:

prompt information obtained according to a user instruction;

prompt information sent by another device;

prompt information automatically generated according to a user intent;

prompt information generated based on a preset manner.

Wherein, the user instruction may include, but is not limited to, an instruction for indicating to generate the prompt information issued by the user, an instruction sent by another device, or an instruction for editing the image by the user. In addition, the specific form of the user instruction is not limited in the embodiment of the present disclosure, and may include, but is not limited to, a voice instruction, a text instruction, and the like. In the subsequent description of the embodiment of the present disclosure, a voice instruction is used to indicate the user instruction.

For example, if the user issues a voice instruction “help me establish a reminder to take medicine at 10 am tomorrow”, the corresponding prompt information may be obtained based on the voice instruction, for example, the prompt information may be the information that the content is taking medicine and the reminding time is 10 am tomorrow.

For the prompt information generated based on a preset manner, the preset manner may include, but is not limited to, a text manner, a non-text manner, and the like. Specifically, when the preset manner is the text manner, the generated reminder information may be information in the form of text, and the specific text content of the prompt information at this time may be obtained based on a user instruction, or may be the prompt information received from another device, or may also be automatically generated according to the user intent; the non-text manner includes but is not limited to a specific non-text display manner, for example, it can change the attribute information of objects in the view image, or the attribute information of other related object. Specifically, you can highlight the object, change the color and change other attribute information of the object in the view image.

In an alternative embodiment of the present disclosure, the user intent may be obtained by at least one of the following manners:

obtaining a historical image of the user;

recognizing the user intent based on the historical image.

Specifically, by recognizing and analyzing the historical image of the user, the user's possible intent may be determined, so that the corresponding prompt information may be automatically generated based on the analyzed user intent.

The solution of the embodiment of the present disclosure can automatically analyze the user intent based on the historical image of the user to analyze the possible requirement of the user, so that the corresponding prompt information may be automatically established for the user according to the requirements. Through this method, it is possible to establish corresponding reminder items for the user without requiring the user's active participation, thereby better satisfying the user's requirements. Wherein, when the prompt information is automatically generated based on the user intent, the based object when the prompt information is displayed may be an object associated with the user intent.

Certainly, in practical applications, as an alternative manner, after the corresponding prompt information is generated based on the user intent, the user may be prompted whether the reminder item needs to be established, and the prompt information is then saved (that is, establishing the reminder item of the prompt information) after receiving the feedback that the user determines to establish the reminder item. If receiving the feedback that the user does not want to establish the reminder item, the prompt information may not be saved, that is, canceling the establishment of the reminder item.

In an alternative embodiment of the present disclosure, the above object may be determined according to at least one of the following information:

object indication information carried in a user instruction;

*138a user's focus point in the user view image;

personalized information of the user;

a historical behavior of the user for the object;

information sent by another device that may be used for determining the object;

Wherein, the object indication information carried in the user instruction may be information that explicitly indicates the object, or may be information that may be used to determine the object according to the object indication information, for example, may include the attribute information of the object. For example, if the user instruction is “Establish a reminder tag for sending a mail on this computer”, the object indication information in the instruction is “This computer”, and the indication information is plain text indication information. For another example, if the user instruction is “Help me to set a reminder of sending a mail on this red object”, then the object indication information in the instruction is “Red object”, wherein red is the color attribute of the object, and then the real object indicated by the red object may be recognized as the object through performing recognition on the user view image.

It should be noted that, in the embodiment of the present disclosure, the user's focus point may include a gaze point of the user's eye and/or a pointing point of other parts of the user, for example, the focus point may be a pointing point of a finger or other parts.

The personalized information of the user refers to the user information related to the user itself, and may include but is not limited to the user's interest, age, gender, occupation, geographical position, social relationship, content of interest to the user, user behavior, user habit, preference and other relevant information. In practical applications, based on that the user instruction or other information is not very clear, if the object cannot be determined based on the user instruction and/or other information, or when the optional objects determined based on the user instruction or other information are more than one, it may determine one object according to the user's personalized information (for example, user preferences).

For a user's historical behavior for the object, the object at this time may include, but is not limited to, an object associated with the behavior when the user makes this behavior. As an alternatively method, the user's behavior may be recognized by analyzing the user image, and the object associated with the behavior is used as the base object when displaying the prompt information, for example, one or more historical images of the user may be obtained, the historical behavior of the user is determined by analyzing the images, and the object is determined based on the behavior.

In addition, the object may be determined according to the information that may be used to determine the object sent by another devices, wherein the specific form of the information that can be used to determine the object is not limited in the embodiment of the present disclosure, as long as it can be used to determine the object information in the user view image. For example, the information that can be used to determine the object information may be the name of the object, or may be the object indication information. For example, the object indication information may be the feature of the object, specifically such as a feature point of the object in other images, then at this time the object in the user view image may be obtained by the means of feature point matching.

In an alternative embodiment of the present disclosure, the object indication information includes the attribute information of the object, wherein the object is obtained by at least one of the following manners:

determining an image recognition algorithm according to the attribute information of the object and/or a scene in which the user is located; performing the recognition on the user view image according to the determined image recognition algorithm to recognize the object.

In order to improve the accuracy of the image recognition, as an alternative method, before the user's visual view image is recognized, an appropriate image recognition algorithm may be selected by the attribute information of the object carried in the user instruction and/or the scene information of the scene where the user is located. The user view image is recognized based on the selected algorithm, thereby improving the accuracy of the recognition and reducing the overhead of the computing resource. Certainly, the object that needs to be recognized from the image may be determined based on any of the foregoing methods.

In an alternative embodiment of the present disclosure, after obtaining the prompt information and the object in the user view image, the method may further include:

displaying the prompt information in the user view image based on the object.

Specifically, the prompt information may be displayed on the object in the user view image by the AR/VR device based on the position information of the object in the user view image.

It may be understood that when the prompt information is displayed in the user view image, the view image is the user's current view image. When the prompt information needs to be displayed to the user continuously for a period of time, the view image may be a frame image in the collected video stream of the user's view, and when continuously displaying the prompt information, the object in the video stream may be tracked by means of object tracking; the prompt information is displayed to the user based on the object in the different frames of images. In other words, the object in the user's current view image may be determined based on the object in the historical view image of the user.

In one alternative manner, in actual applications, the image recognition algorithm may be determined according to the attribute information of the object and/or a scene in which the user is located; the historical view image of the user is recognized according to the determined image recognition algorithm to recognize the object in the historical view image; then the object in the current view image is determined according to the object in the historical view image.

For this manner, specifically, the historical view image may be recognized by the determined image recognition algorithm to obtain the object identification information of the object in the historical view image, and the object in the current view image may be recognized based on the identification information. In other words, the object tracking may be performed based on the relevant information of the object in the historical view image to determine the object in the current view image. Wherein, the object identification information may be a feature point of the image area where the object is located in the historical view image, and at this time, the object in the current view image may be determined by performing feature point matching between the historical view image and the current view image.

In another alternative manner, the image recognition algorithm may also be determined according to the attribute information of the object and/or a scene in which the user is located; the recognition is performed on the historical view image of the user according to the determined image recognition algorithm to recognize the object in the historical view image ; then the object in the current view image is determined according to the scene position information of the object in the scene where the user is located.

For a fixed scene (which may be a real scene or a virtual scene) where the user is located, the scene position information of each object in the scene is generally fixed. In this case, by obtaining a panoramic image of the scene in advance, the scene position information of each object in the scene is obtained based on the panoramic image. After the object in the historical view image is determined by performing recognition on the historical view image, since the scene position information of the object is fixed, consequently, at this time, the object in the current view image may be determined based on the scene position information of the object.

Based on any of the above manners, the tracking processing on the object may be realized, so that the prompt information may be displayed to the user based on the position information of the object in each view image of the user.

In an alternative embodiment of the present disclosure, the method further includes:

when position information of the object changes, displaying the prompt information in the user view image according to the changed position information of the object.

In practical applications, when the user moves or the object in the scene is moved, the position of the object in the user view image also changes. At this time, the object may be determined by re-recognizing the user view image, or the object in the user view image may be found by means of object tracking.

In an alternative embodiment of the present disclosure, when the object is not located in current view image, the method further includes at least one of the following steps:

generating guidance information of the object to locate the object in the current view image based on the guidance information;

displaying the prompt information in the user view image;

sending the prompt information to another device to display the prompt information to the user through the another device.

In order to avoid that the object leave the current view of the user due to the change of the current view of the user or other reasons when displaying the prompt information, the prompt information may be ensured to be displayed to the user by any of the above methods.

In an alternative embodiment provided by the present disclosure, by using the AR/VR scene information (including images) in combination with the ASR technology and the NLU technology, the user is provided with a new experience AR/VR-based reminder service.

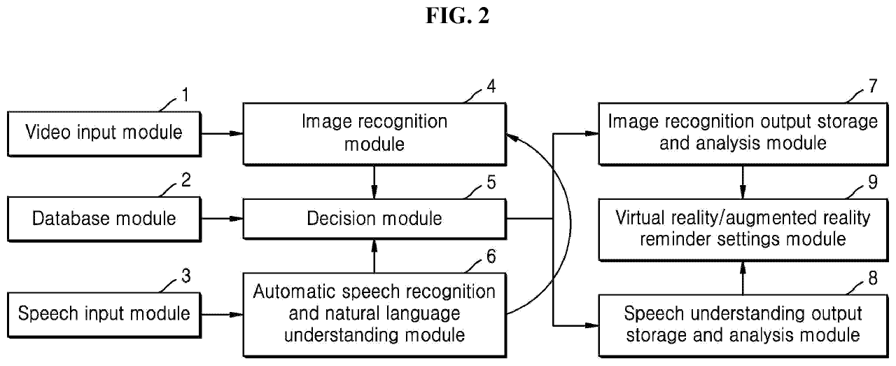

As an alternative manner, FIG. 2 illustrates a schematic structural diagram of a prompt information processing system that is suitable for the embodiment of the present disclosure. As shown in FIG. 2, the system may mainly include 9 modules: a video input module 1, a database module 2, a speech input module 3, an image recognition module 4, a decision module 5, an automatic speech recognition and natural language understanding module 6, and an image recognition output storage and analysis module 7, a speech understanding output storage and analysis module 8, and a VR/AR reminder setting module 9.

It should be noted that, in practical disclosures, each module in the processing system may be deployed on one or more devices according to actual application requirements, for example, may be respectively deployed on one or more devices such as a terminal device, a cloud server, and a physical server.

For the above respective modules, the video input module 1, the database module 2, and the speech input module 3 are input portions of the system; the image recognition module 4, the decision module 5, and the automatic speech recognition and natural language understanding module 6 are the main information processing portions of the system; the image recognition output storage and analysis module 7, the speech understanding output storage and analysis module 8, and the VR/AR reminder setting module 9 are the output and storage portions of the system. Specifically:

1. The video input module 1 may specifically be the camera input of the AR device or the scene input renderer by the VR device, or may be a user image and/or a user view image collected by other image collecting devices, where these provide the entire system with image information of the scene seen by user or the scene where the user is located.

2. The database module 2 is the storage part of the system, which is used to store the preset system data and the key information extracted from users' usage habits and historical data analysis, and the key information may include the user's personalized information, relevant information of scene information, and relevant information of the object (i.e., a subject), etc.; the key information may be stored in a device used by the user, or may be stored on a dedicated server connected through a network, and may be adjusted and updated.

3. The speech input module 3 is a speech collection portion of the system, including but is not limited to a microphone of the device. The speech input module converts the user's voice instruction into a digital electronic signal to provide other modules of the system with a source of voice data that may be analyzed.

4. The image recognition module 4 continuously receives image signals from the video input module 1, and may extract objects existing in the scene and their positional relationships through image recognition technology and scene understanding technology.

5. The automatic speech recognition and natural language understanding module 6 may convert the electronic voice signal output by the speech input module 3 into text information through automatic speech recognition technology, and analyze the text information through the natural language understanding technology to understand the user intent.

Wherein, a part of the information output by the automatic speech recognition and natural language understanding module 6 may be used as an input of the image recognition module 4, where this part of information is unnecessary input information of the image recognition module 4, but as an alternative solution, this part of information may be used to enable the image recognition module 4 to select an appropriate image recognition algorithm to improve the accuracy of the recognition and reduce the overhead of the computational resource.

6. The decision module 5 receives the output from the image recognition module 4 and the automatic speech recognition and natural language understanding module 6, where the module may provide a high-precision result for image recognition and a high-precision result for speech recognition and natural language understanding through comprehensive judgment of image information and speech information.

7. The image recognition output storage and analysis module 7 receives the output information from the decision module 5, where the information is related to the output result of the image recognition module 4, except that the information output by the image recognition module 4 is the sum of all information of image recognition in the current scene, and the image recognition output storage and analysis module 7 saves useful information for the user thereof, in which saves not only the current useful information but also historical information. The module is also responsible for analyzing the time-sequence relevant information to obtain the usage intent of the user.

8. The speech understanding output storage and analysis module 8 receives the output information from the decision module 5, where the information is related to the output result of the automatic speech recognition and natural language understanding module 6, except that the information output by the module 6 is the sum of all information of the speech understanding in the current scene, and the module 8 saves useful information for the user thereof, in which saves not only the current useful information but also historical information. The module is also responsible for analyzing the time-sequence relevant information to obtain the usage intent of the user.

Wherein, it should be noted that the above-mentioned useful information described in the module 7 and the module 8 refers to information that has an effect on the recognition of scene state, object, user's action behavior intent, user's language intent, and the like.

9. The VR/AR reminder setting module 9 is mainly responsible for storing reminder information of different places, different scenes and different periods of time of the user, and is responsible for displaying the information to the user through the VR/AR device by means of virtual reminder tag in suitable place, scene and time, or may also present the reminder information corresponding to the tag to the user through voice broadcast or other manners when the virtual reminder tag is not in the view of the AR/VR.

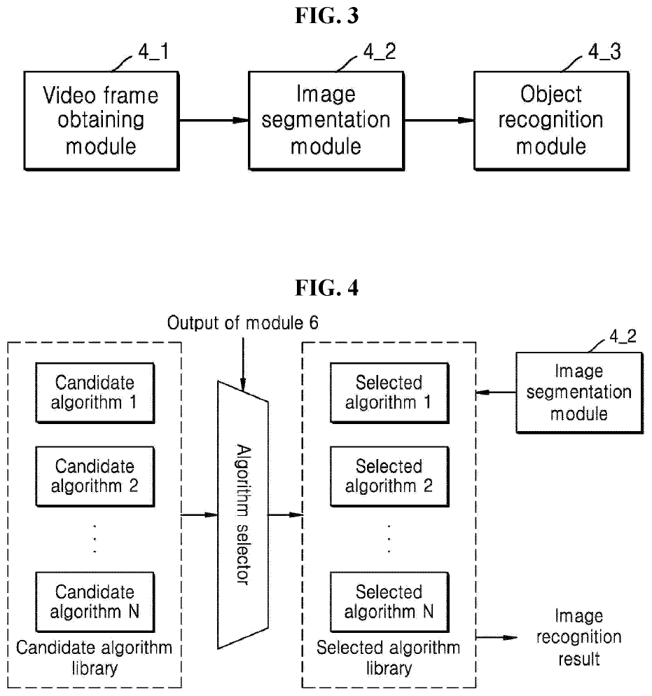

As an alternative solution, FIG. 3 illustrates a schematic structural diagram of an image recognition module. As shown in the figure, the recognition module in the solution may include a video frame obtaining module 4_1, an image segmentation module 4_2, and an object recognition module 4_3.

Wherein, the video frame obtaining module 4_1 uses the video stream data output by the video input module 1 as input information for decoding, and its output is video frame data, and the data of each frame includes complete scene picture information, and the module 4_1 may flexibly adjust the frame rate of the video frame to be calculated by means of frame extraction according to the condition of the computing resources of the system.

The image segmentation module 4_2 is configured to perform object segmentation on the obtained image, and segment different objects to provide a segmented object image for the subsequent object recognition, wherein the image segmentation algorithm used by the image segmentation module may include but is not limited to a Region-based Convolutional Neural Network (R-CNN), Fast Region-based Convolutional Neural Network (Fast R-CNN), Faster Region-based Convolutional Neural Network (Faster R-CNN), Mask Region-based Convolutional Neural Network (Mask R-CNN), etc. This module may use one or more of the above methods in the embodiment of the present disclosure, or may use other methods instead as the technology progresses.

The input data of the object recognition module 4_3 may be divided into two parts, one part is from the input of the image segmentation module (that is, each object after the segmentation is input into the module for calculation and recognition), and the other part is unnecessary input, (i.e., the output of the automatic speech recognition and natural language understanding module 6). In other words, within the module, different image recognition algorithms (one or more) may be selected according to the result of the speech recognition. If there is no output information of the module 6, according to different scenes, a predefined algorithm setting may be selected as the algorithm combination selected at this time.

As an example, FIG. 4 illustrates a schematic diagram showing the operation principle of the image recognition module provided by the embodiment of the present disclosure; as shown in the figure, in actual applications, N different image algorithms may be stored in this module in advance, specifically, such as the candidate algorithm 1, the candidate algorithm 2, . . . , the candidate algorithm N as shown in the candidate algorithm library in the figure. Different algorithms may be calculated for the same problem, or may be calculated for different problems. For example, there are two algorithms that calculate the color and obtain the color of the current object, but one algorithm excludes the illumination interference to obtain the color close to the object itself, and the second case does not exclude the illumination interference, so the obtained color is close to the user's real experience as much as possible. Other algorithms may include, but is not limited to, an algorithm for describing a shape, an algorithm for recognizing an object class, and the like, and the sum of these algorithms may be collectively referred to as a candidate algorithm library. In this example, it is assumed that the total number of algorithms for calculating object characteristics in the candidate algorithm library is N, and the number of N is not fixed and may be increased or decreased as the system is updated.

The algorithm selector shown in FIG. 4 needs to select an algorithm that needs to be operated in the candidate algorithm library, and the selection may depend on the output of the automatic speech recognition and natural language understanding module, or may be the algorithm selecting preset for different scenes. It is assumed that a total of M algorithms (the selected algorithm 1, the selected algorithm 2, . . . , the selected algorithm M as shown in the figure) are selected for calculation and analysis on the image. Wherein, the value of M may be adaptively changed according to different voice instructions or changes of the scene. For example, when the instruction indicates that a yellow cup needs to be marked, the algorithm that may be simultaneously enabled or selected should include at least a color recognition algorithm and an object classification algorithm. The result of image recognition (i.e., the output of the object recognition module) may be a set of results, obtained by the algorithms in the selected algorithm library of the scene image.

For the automatic speech recognition and natural language understanding module 6, at present, the voice is usually converted into text by the automatic speech recognition algorithm first, and then compositional analysis is performed on the text by natural language understanding to find the actual purpose of the user instruction. Although the existing automatic speech recognition has been able to correct errors as much as possible according to the context of a sentence, the recognition errors caused by environmental influences, user accents and the like will affect the correct analysis of subsequent natural language understanding parts, resulting that the system incorrectly understand the user instruction. In practical applications, there are still cases that the user who uses a pronoun to represent the real object. Although the automatic speech recognition module correctly converts the user's voice instruction into text, there is still a problem that the natural language understanding part cannot correctly analyze the user's actual intent.

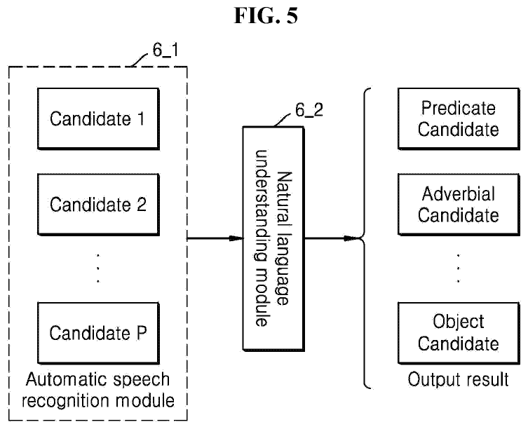

For the above problems, as an alternative solution, FIG. 5 illustrates a schematic diagram showing the structure and the operation principle of the automatic speech recognition and natural language understanding module provided by an embodiment of the present disclosure. As shown in FIG. 5, the module may specifically include an automatic speech recognition module 6_1 and a natural language understanding module 6_2. Wherein, when the automatic speech recognition module 6_1 recognizes the speech input, several most possible options may be given for the uncertain words (the candidate 1, the candidate 2, . . . , the candidate P as shown in the figure), then the natural language understanding module 6_2 may further exclude some impossible options according to the constraint relationship between words, and perform component decomposition, such as decomposing objects (grammar), predicates and adverbials, and may give multiple possible options for the uncertain parts (predicate candidates, adverbial candidates, . . . , object (grammar) candidates, etc., as shown in the figure), which may be further determined by the decision module.

The decision module 5 can make a judgment according to the combination of language understanding and image information. Specifically, the decision module may receive the analysis result from the module 6, and the information obtained from the database module 2 may be used to learn whether the user habitually refers to one object by using another appellation, or describes one action instruction by using another expression. If there is such a habit, the standard appellation may be used to replace the corresponding expression in the analysis result to perform the replace operation, for eliminating ambiguity. Then, the decision module 5 may perform judgment according to the attribute information of the object in the actual scene, accurately map the user instruction with the actual scene, and finally obtain the result of the object recognition and the speech recognition accurately, and at the same time it may also screen objects unrelated to the instruction, and output useful information to module 7 and module 8.

For example, as an example, it is assumed that there is a red teapot in the user's scene, the user wants to establish a reminder on the teapot to remind the meeting in tomorrow morning, and the user is accustomed to call the teapot “can-can”. When the user issues the instruction “mark the reminder of the meeting in tomorrow morning on that red can-can”, the image recognition module 4 may activate the color recognition algorithm, the shape recognition algorithm and the object recognition algorithm, and recognize that there are a red apple and a red teapot on the table; then the automatic speech recognition and natural language understanding module 6 obtains that the action is to establish a reminder, the reminder content is “meeting in tomorrow morning”, the adverbial is “on the red can-can” by analysis, and then after compared with the data stored in the database module, it is determined that the user is accustomed to refer the teapot as “can-can”. Therefore, based on the data in the database module, the adverbially actual expressed by the user may be obtained as “on the red teapot”, and the option of establishing a reminder on the red apple is excluded, and finally it is determined that the output of the image is the red teapot in the scene by analysis; the output of the automatic speech recognition and natural language understanding module is “Establish a reminder of meeting in tomorrow morning on the red teapot”, so that the real scene, the user's instruction, and the user's personalized information (the user's calling habits of the object in this example) are well correlated, thereby increasing the accuracy of image recognition and the accuracy of speech recognition.

In addition, as known from the foregoing description, the image recognition output storage and analysis module 7 and the speech understanding output storage and analysis module 8 provided by the embodiments of the present disclosure may not only store the actions and instructions of the current user, but also store the historical recognition information. These historical information may be allocated with different storage spaces according to the importance, frequency and time proximity of the information, so as to provide accurate information while saving storage spaces, for example, including but being not limited to, by using a simple rule, retaining the complete original recognition data for the most recent high frequency recognition result, and performing classification compression on long-term results and only retaining the conclusion information.

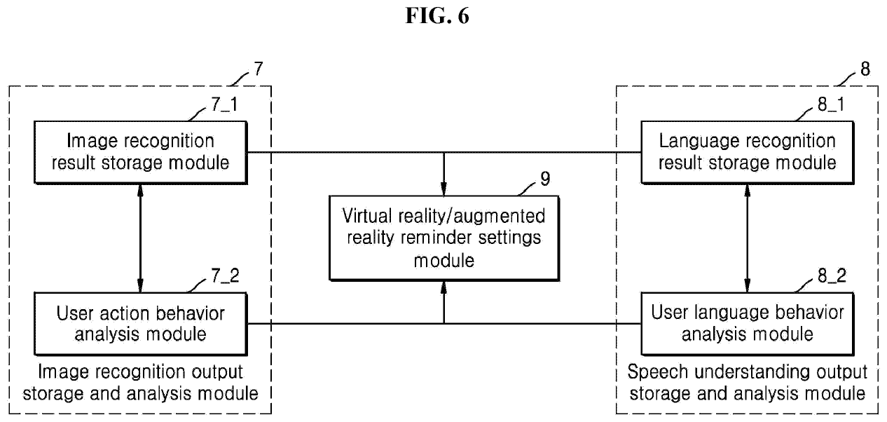

As an alternative solution, FIG. 6 illustrates a schematic structural diagram of the image recognition output storage and analysis module 7 and the speech understanding output storage and analysis module 8 provided in the embodiment of the present disclosure. As shown in the figure, the module 7 specifically contains an image recognition result storage module 7_1 and a user action behavior analysis module 7_2, and the module 7_2 may be responsible for obtaining data stored in the module 7_1, and determining the user's specific behavior actions, and then the generated behavior action may also be re-stored in module 7_1 as important information of the current time.

In practical applications, since the action recognition is the result of some data generated by the module 7_1, after a long period of time, in order to reduce the storage space required for data storage, the original judgment data may be deleted while only retaining the result of the action, to play the role of data compression. In addition, since the current motion analysis may provide algorithm basis and data support for future action analysis, and may help to improve the data stored in the module 7_2. Therefore, the module 7_2 may determine the user's specific behavioral actions data through the data obtained from the module 7_1, to improve and update the data in module 7 2.

Similarly, the module 8 also contains two modules, that is, the language recognition result storage module 8_1 and the user language behavior analysis module 8_2 shown in the figure. The internal structure of the module 8 is different from that of the module 7, where they use different algorithms for different contents, wherein the module 7 uses analysis for image content, the decomposed result is the action behavior, and the module 8 uses analysis for language content, the analyzed result is the language behavior. The module 9 is the VR/AR reminder setting module, and may obtain data from the module 7_1, the module 7_2, the module 8_1, and the module 8_2, and comprehensively determine the behavior action of the user and the content that needs to help the user automatically mark.

For a better explanation and understanding of the solution provided by the embodiment of the present disclosure, the relevant content of the solution provided by the embodiment of the present disclosure is further described below with reference to some examples.

### EXAMPLE 1

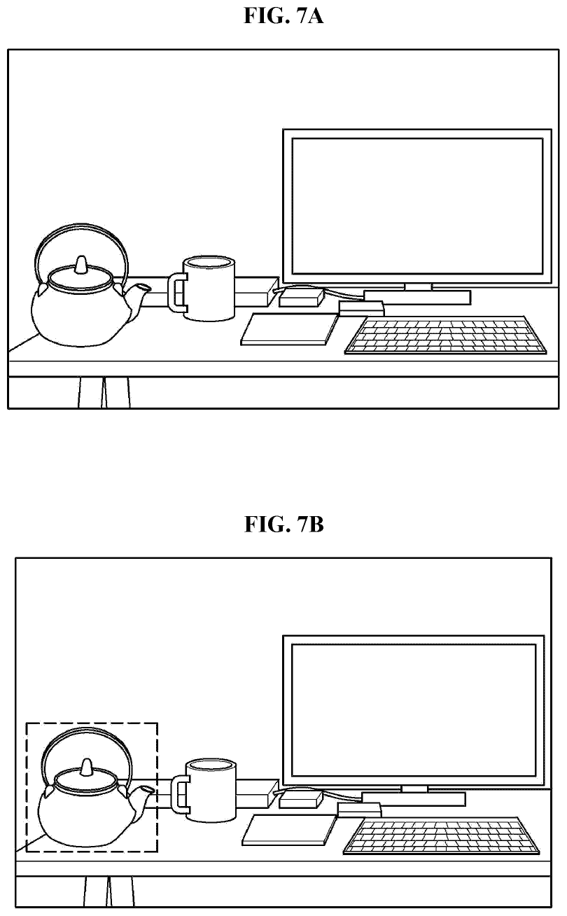

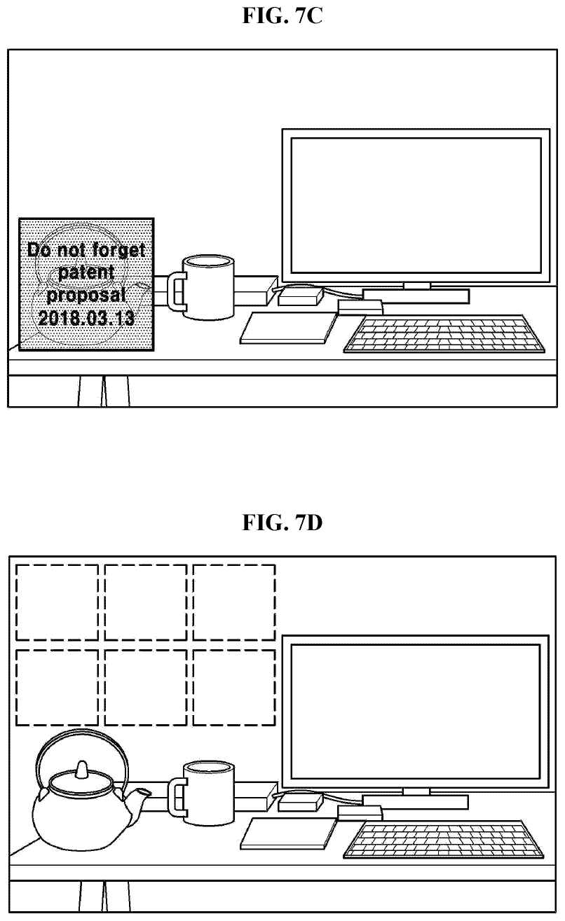

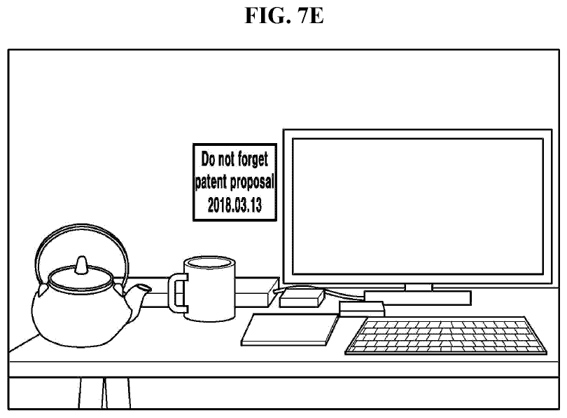

A scene diagram of a solution of processing prompt information in the present example is shown in FIG. 7A, and the user may obtain the user view image shown in FIG. 7A through the AR device carried by the user. When the user needs to establish a reminder item, the AR device may be used to issue an instruction to establish a reminder, such as “put a note on the teapot, and mark: do not forget patent proposal”. For the speech input, the text information generating the speech input may be analyzed by the automatic speech recognition module, and all morphemes in the text information are obtained by the natural language understanding module. In this example, the morpheme may specifically include: the object (grammar): “a note”, the adverbial: “on the teapot”, the information: “do not forget patent proposal”, and the behavior: “put”. For the image recognition module, the image recognition algorithm that needs to be executed may be selected according to the content of the voice instruction. For example, the image recognition algorithm in this example may include a shape recognition algorithm and an object recognition algorithm. Based on the shape recognition algorithm, an object similar to the size of the teapot may be found, and through the object recognition algorithm, an object whose category is a teapot may be found. The selected image recognition algorithm is used to confirm that there is a red teapot in the lower left corner of the scene observed by the user, and the obtained object for displaying the prompt information in this example is specifically the teapot in the dashed rectangle box shown in FIG. 7B. The decision network (i.e., the decision module) saves the image recognition result and the language understanding result by summarizing the input information of image and voice. Finally, the reminder setting module of the AR system (the processing system in this example) obtains an accurate instruction and accurately sets the reminder item (i.e., the reminder information), which specifically is shown in FIG. 7C: based on the recognized teapot, the prompt information (“do not forget patent proposal 2018.03.13” shown in the figure) obtained based on the user voice instruction may be displayed in the current view image of the user in the form of note, wherein, the time (2018.03.13) in the reminder information in the figure may be the date when receiving the user's voice instruction. Certainly, in practical applications, if the user gives the reminder time, the time displayed in the prompt tag may also be the time when the user needs to be reminded, for example, if the user instruction is “help me put a note on the teapot: do not forget patent proposal tomorrow”, then the prompt information in FIG. 7C may be “do not forget the patent proposal 2018.03.14”.

It may be understood that in the present example, the user view image shown in FIG. 7A may be the same image as the user view image shown in FIG. 7C, or may not be the same image. This is because, in practical applications, even if the user has not moved during the entire process, the collecting time of the user view image shown in FIG. 7C may be the same as the user view image shown in FIG. 7A in time sequence, or may not be the same image. In addition, if the user moves after obtaining the image shown in FIG. 7A, the user view image shown in FIG. 7C is possible different from the user view image shown in FIG. 7A while displaying the prompt information. If it is the same image or the user has not moved, the prompt information may be displayed based on the position of the teapot in FIG. 7A, and if the user has moved, when the image changes, the view image in FIG. 7B may be performed point matching with the current view image based on the feature point information of the image area where the teapot is located as shown in FIG. 7B and that is recognized when performing image recognition. Based on the feature point information of the teapot in FIG. 7B, the current position information of the teapot in FIG. 7C is determined, and based on the position information, the reminder tag is displayed in the user view image as shown in FIG. 7C.

### EXAMPLE 2

The scene shown in FIG. 7A is still taken as an example. In this scene, when there are multiple options available to the user's instructions, the system may query the user and give suggestions, and record the user's selection preferences after the user makes the decision so as to provide better service to the user.

Specifically, assuming that the user instruction is “set a reminder on the wall for not forgetting patent proposal”, the image recognition module recognizes the position of the wall in the scene image by recognizing the user view image shown in FIG. 7A, and the information in the user instruction corresponds to the object in the scene by recognizing the user instruction, and multiple optional objects may be found at this time, for example multiple areas of the wall as shown in the dashed box in FIG. 7D. Since there are many choices for the user's fuzzy demonstration, meanwhile, the system may ask the user and give suggestions according to the user's habits, for example, a feedback may be made based on the user instruction, such as “OK, where do you want to put, right lower corner?”. If the response of the user is received based on the feedback, such as “right lower corner, ok”, then the prompt information (“Do not forget patent proposal: shown in the figure) may be displayed on right lower corner of the wall in the current view image of the user based on the feedback of the user, as shown in FIG. 7E. In addition, the system may also remember the user's choice, and store the relevant information of the user into the user database of the database module based on the user's selection, and update the personalized information of the user.

### EXAMPLE 3

In the application scene given in Example 2, there is a given solution of how to perform processing when there are multiple positions in the corresponding actual scenes. In the application scene of this example, when the user does not explicitly indicate the displayed form of establishing the virtual reminder, the system may also give suggestions according to the user's preference.

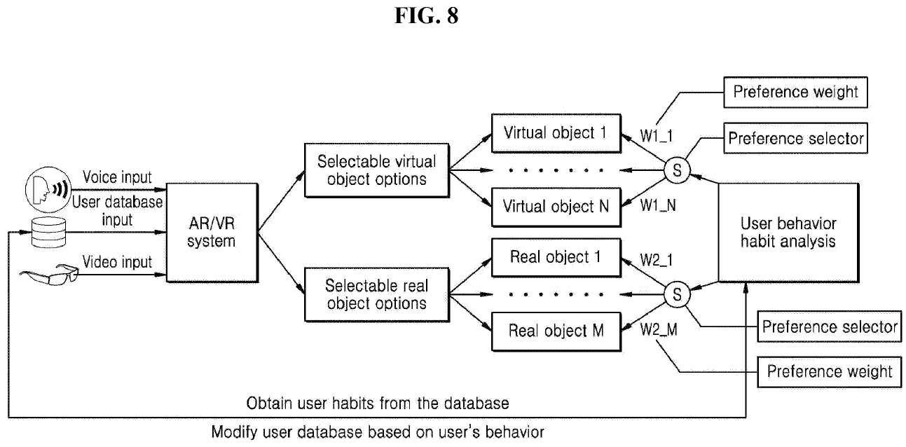

As shown in FIG. 8, for an AR scene, when the system obtains a plurality of selectable real object options for displaying prompt information, that is, when there are multiple selectable objects, or for a VR scene, when the system obtains a plurality of selectable virtual object options for displaying prompt information, the system may use the preference selector to establish weights for respective selectable objects according to the user's preference. As shown in the figure, assuming that the number of selectable real objects is M, W2_1 shown in the figure represents the weight of the first selectable real object, W2_M represents the weight of the Mth selectable real object; similarly, W1_1 represents the weight of the first selectable virtual object, and W1_N represents the weight of the nth selectable virtual object, wherein the preference selector may set the above weights based on the analysis result of the user behavior habit analysis, that is, the weights are set according to the user's habit, and the user behavior habit information may be obtained from the user relevant information stored in the database module (the user data shown in the figure). After that, when the system encounters fuzzy demonstration, the system may make recommendations according to the user's historical weights, and update the weights and save these weights into the database after the user finally makes a choice. The initial value of the weight may be given an initial value by counting the behavioral habits of most users.

### EXAMPLE 4

The scene shown in FIG. 7A is still taken as an example in this example. In this example, the user needs to establish a reminder on the teapot by using the AR system (the prompt information processing system in this example).

For the speech part, the AR system (for example, through the AR device) collects the user's voice instruction, and then recognizes the text information of the user voice instruction as: “establish a reminder note that do not forget to send a mail tomorrow on the red pot-pot” through the automatic speech recognition module, and then segments the statement through the natural language understanding module to obtain a combination of the action and the object (grammar) as “establish a reminder note”, the note content as “do not forget to send a mail tomorrow”, and the adverbial as “on the pot-pot”; a part of the information obtained through the natural language understanding module may be provided to the image recognition module, and all analysis results are provided to the decision network (i.e., the decision module).

For the image part, the camera of the AR device may collect the video of the scene, at least one frame image thereof is sent to the image recognition module. The image recognition module may first distinguish different objects in the scene through the image recognition algorithm. For example, the trained convolutional and deconvolutional network may be used to segment different objects in the scene; since the user's need is to establish a note on the “red teapot”, for the image recognition module, the algorithm selector thereof may select and use the color recognition algorithm and the object detection algorithm, and the segmented image is recognized by the selected algorithm, and the recognized red object is the teapot.

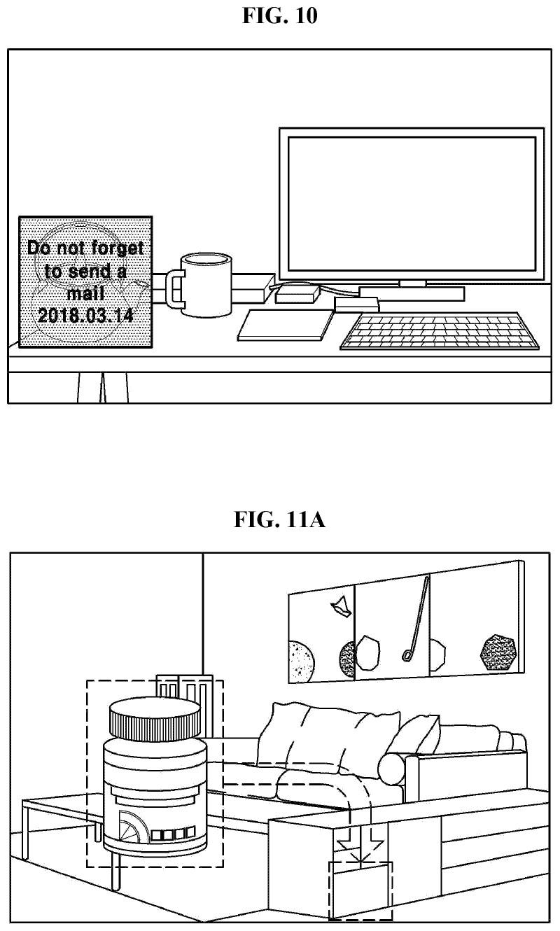

The decision network determines that the red object in the scene is the “teapot” after comparison and analysis based on the output result of the image recognition module and the natural language understanding module; then comprehensively judges that “the red pot-pot” expressed by the user refers to “the red teapot” in the scene according to the user database; through comprehensive judgment, the useful object in the scene (i.e., the red teapot) is used as the output result of the image recognition, and the instruction of the user is modified as “establish a reminder note ‘do not forget to send a mail tomorrow’ on the red teapot”, and finally the reminder setting module of the system completes the setting of the reminder tag, and the reminder tag is displayed in the user view image based on the red teapot, as shown in FIG. 10. The time of the prompt information in the figure may be the actual time corresponding to “tomorrow”, and certainly, the specific content of prompt information may also by “do not forget to send a mail tomorrow 2018.03.13”, wherein the time in the information may be the time when the user issue the instruction.

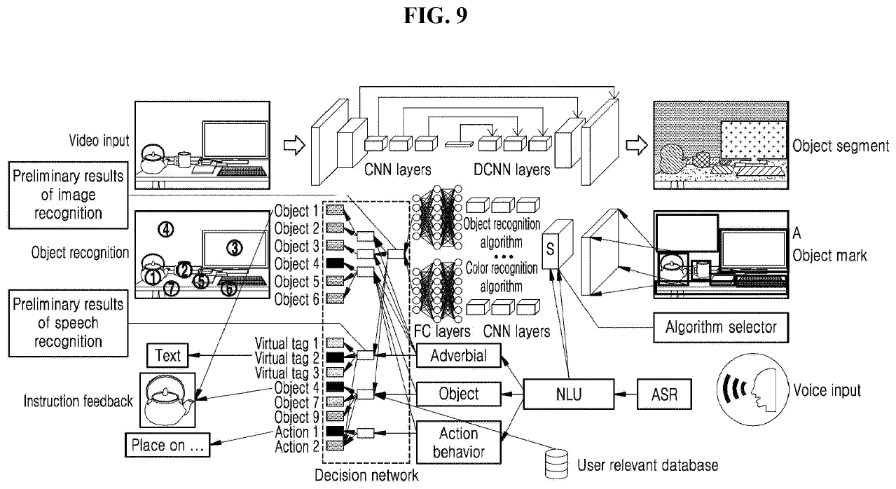

FIG. 9 is a schematic structural diagram of the processing system for implementing the above prompt information processing method in the present example provided in the present example. As shown in FIG. 9, the image recognition module may include an image segmentation network (convolutional neural network (CNN) layers+deconvolutional neural network (DCNN) layers shown in the first layer in the figure) and an image recognition network (CNN layers+fully connected (FC) layers shown in the second layer), wherein the image recognition network includes an algorithm selector (module S shown in the figure).

The video input and the speech input may co-influence the decision network to help the machine understand the user's intent accurately. Preliminary results of image recognition may help to eliminate the alternatives in speech recognition results. Preliminary results of voice recognition including adverbial, object, and action help to find the right objects in the image decision network. The mutual fusion of image and voice information enables rapid and accurate recognition in a specific scene.

For the obtained image, that is, the video input (the image shown in FIG. 7A in this example), the image segmentation result (the image of the object segmentation part shown in the figure) is obtained by the processing of the image segmentation network; the image A with segmentation mark (the rectangular frame shown in the image A of the figure) is obtained based on the image segmentation result; the information (the red pot-pot) obtained based on the user's speech input may be used as an input of the algorithm selector; the algorithm may be determined, based on the input, as the object recognition algorithm and the color recognition algorithm; the image recognition network performs recognition on image A based on the determined algorithm, and obtains the preliminary recognition result of the image (the output of the FC layers shown in the figure, that is, the partial input of the decision network).

For the user's speech input, the ASR module and the NLU module may analyze and obtain that the action behavior in the speech input information is “establish”, the object (grammar) is “reminder note”, and the note content is “do not forget to send a mail tomorrow” (not shown in the figure), and the adverbial is “on the red pot-pot”.

The recognition result of the user voice instruction (the preliminary result of the speech recognition shown in the figure), the preliminary recognition result of the image (the preliminary result of the image recognition shown in the figure), and the information (such as the personalized information of the user) stored in the database module (the user relevant database shown in the figure) may be used as the input of the decision network; based on the speech recognition result, the image recognition result and the user's relevant information, the decision network comprehensively judges that the useful object output in the scene is the object 1 (i.e., red teapot) for displaying the prompt information; the object is an object on which the prompt information is attached, the specific content of the prompt information (the text shown in the figure) may be “do not forget to send a mail 2018.03.14” show in FIG. 10, and the output adverbial “on . . . ” as well as the action information “put” are used to indicate the position of the prompt tag corresponding to the teapot.

### EXAMPLE 5

In this example, a solution for automatically generating prompt information based on user behavior is provided.

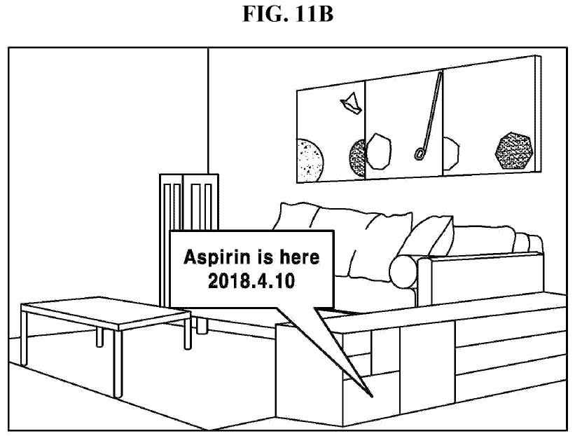

FIGS. 11A and 11B illustrate schematic diagrams of the scene in this example. In this example, the device that generates the prompt information based on the user image and the display device that display information are both interpreted with AR glasses as an example. Specifically, when the user wears the AR glasses, the aspirin vial is placed in the lower left drawer of the cabinet shown in FIG. 11A, and the image collecting module collects the video stream that the user puts the vial into the drawer, the video stream acting as the visual input is input to the image recognition module, and the image recognition module obtains information about the medicine in the user's hand, detects the user's cabinet, recognizes the action that the user pulls out the cabinet in the lower left corner and puts the medicine in the drawer, and then according to this action, the system (the AR system in this example) may assist the user to automatically record a reminder marked with current time information, position information, and medicine information; as shown in FIG. 11B, when the user needs to find the medicine again, the reminder may quickly assist the user to find things that he puts. It should be noted here that when the action behavior occurs, the relevant language behavior may occur at the same time, and then the language behavior will also be recorded in the reminder when recording; if the language behavior is the irrelevant behavior, it will not be recorded together in the same reminder.

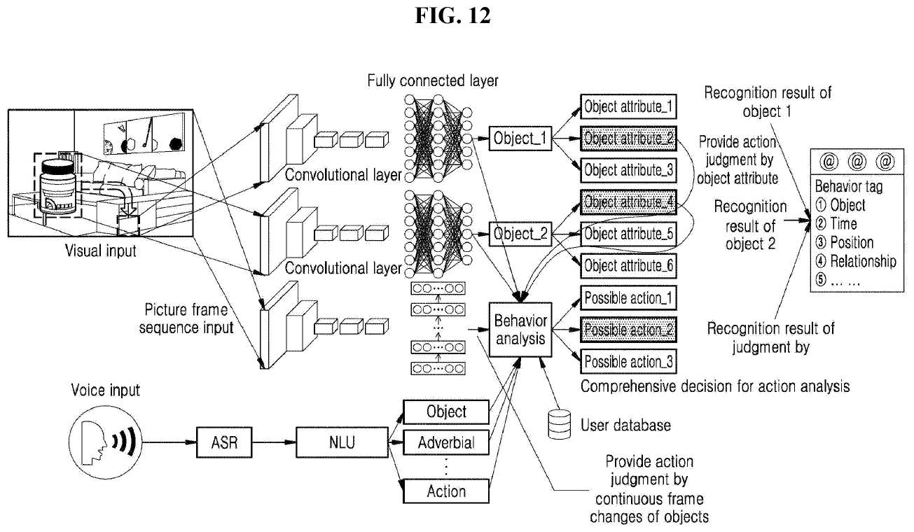

FIG. 12 is a schematic diagram of the system for implementing the prompt information processing method in the present example. As shown in FIGS. 11A and 11B, this example shows a scene in which a user places medicine. The following describes how the algorithm modules of respective parts of the system are specifically coordinated:

As shown in FIG. 12, in this example, the recognition function for an object in image recognition may be composed of a convolutional neural network (the convolutional layer shown in the figure) and a fully connected layer, which specifically are the two branches in the upper half shown in the figure. Through the network structure, the two associated objects in the scene may be recognized: the vial (i.e., the object 1 in the figure) and the drawer (i.e., the object 2 in the figure). For the medicine vial, its attributes include: 1. the type of stored medicine; 2. since the medicine is not easy to be found and needs to be used regularly, they need to be automatically tagged; 3. the aspirin stored in the medicine vial has the function of analgesic, antipyretic, and reducing thrombi. For the drawer, its attributes include: 1. storage for small volume of medicine; 2. storage for shoes; 3. storage for tools and the like. Wherein, the attribute information of the object may be known in advance or may be known by querying online or may be known by querying in the pre-configured object information database.

The action recognition network in this example (the top-down third-layer branch in the figure) may specifically process the input image sequence (the sequence of image frames shown in the figure, i.e., the user video stream) through the convolutional neural network and the recurrent neural network (the RNN layers shown in the figure), to recognize the action of the user placing the medicine in the drawer.

It should be noted that in practical applications, the result of user behavior analysis is the action that the user may execute. Since the network will not determine the user action 100%, but will give the most likely ranking of several options; as shown in the figure, the user behavior analysis is performed based on the user video stream, which may obtain three actions that the user may execute: possible action_1, possible action_2, and possible action 3. The decision network may then comprehensively judge what the user has done and what the intent is based on the result of the image recognition and the result of action recognition.

In practical applications, if the user finishes placing the medicine, and gives a voice instruction “remind me to take medicine at this time tomorrow”, the data by analyzing this instruction through the natural language understanding module, together with the data of the above image recognition, the data of object attributes, the data in the user database and the like, may be used as the input of the behavior analysis module, which are comprehensively judged by the behavior analysis module to obtain the associated action recognition result: the user stores the aspirin in the drawer in the lower left corner, and the system needs to establish a reminder to help the user to find the medicine smoothly and remind the user to take the medicine at this time tomorrow.

Finally, the decision network may obtain the user's behavior tag through comprehensive analysis, based on the result (which may include the recognized associated object, and may also include the object attribute information) of the image recognition and the result of the user action recognition; the tag may specifically include object (i.e., the above associated object), time (i.e., the time when the action occurs), place (i.e., the position when the action occurs, such as in the bedroom or living room, at the bedside or at the side of the cabinet), and relationship (the relationship between the action itself and the object, for example, the relationship between the action of the user taking the medicine and the medicine vial as well as the cabinet storing the medicine vial), accordingly the possible requirement of the user may be obtained by analyzing the tag, thereby generating the corresponding prompt information, and the prompt information may be displayed on the object, for example, a reminder related to the placement of the medicine may be automatically set for the user according to the action of the user. As specifically shown in FIG. 11B, the prompt information “aspirin is here 2018.4.10” may be displayed in association with the cabinet to remind the user that the user has put the aspirin in this cabinet at 2018.4.10.

In addition, in the application scene of this example, it is also possible to find the user's own habits from the user's historical actions according to the data in the user database, or to record periodic actions. For example, the user may customize an action for an instruction, or the user takes medicine every day at noon and night.

In most current AR/VR scenes, people need to bind a piece of tag information to an object in a specific scene. In fact, it will encounter the problem of a non-specific reference. Based on the solution provided by the embodiment of the present disclosure, the AR/VR reminding function based on the non-specific object may be implemented for such a scene. For example, after determining the user intent according to the output of the module 8, it is necessary to make a mark in the object A, wherein the object A here is not a specific reference but a general term for a type of object (also may be understood as the indication information of a list of objects). Then, it may be judged in the output of the module 7 whether there is a special object for the object A, and if there is, the corresponding reminding action may be triggered. Through the solution of the embodiment of the present disclosure, in addition to the user's own requirement for the reminding function, the user may also receive instructions issued by another device having the authority through the network. In other words, the user instruction may be an instruction issued by a user of the current AR/VR device, or may be an instruction sent by another device and received by the current AR/VR device. The manner in which the prompt information in this type of scenes is processed is further described below in conjunction with the example.

### EXAMPLE 6

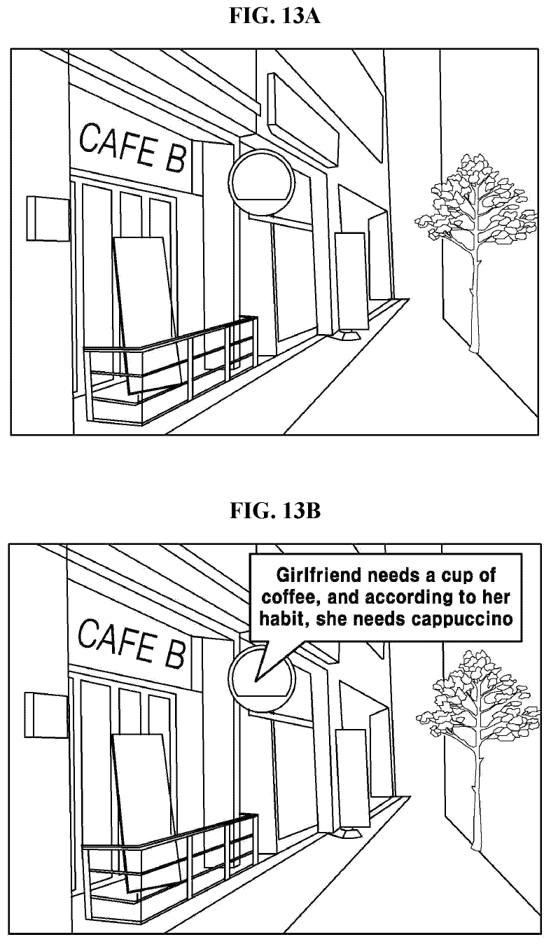

FIGS. 13A and 13B show schematic diagrams of one application scene in this example. In this example, a boy wearing AR glasses walks on the street as shown in FIG. 13A. The boy's girlfriend needs a cup of coffee, and she sends a request of bringing a cup of coffee for her to the AR glasses used by the boy. In this scene, the request is the user instruction in the example, and the “coffee” in the instruction is the object indication information carried in the user instruction, and according to the indication information, it is known that the object to be obtained is a coffee shop. The AR system (which may be AR glasses or a server that communicates with the AR glasses) analyzes the request, and analyzes that it is necessary to set a reminder function at the door of a coffee shop. Since the coffee shop is a non-specific target, during the movement of the boy, the AR glasses may obtain the boy's view images in real time, and the AR system may perform recognition on the view images. When the boy passes by any coffee shop or any coffee shop appears in the view of the boy, the AR system may recognize the sign of the coffee shop through the object recognition, and may create prompt information that bring a cup of coffee for his girlfriend, and may display the prompt information and the recognized coffee shop together in the boy's view image. In addition, in practical applications, the AR system may also learn the girlfriend's preferences by obtaining the personalized information of the girlfriend, and the prompt information may also include the girlfriend's preference information to better satisfy the actual application requirement. Specifically, as shown in FIG. 13B, in this example, based on the personalized information of the user (i.e., the girlfriend) corresponding to the user instruction, it is known that the coffee that the girlfriend likes is cappuccino, and then the prompt information generated by the system may be “the girlfriend needs a cup of coffee, according to her habit, she needs cappuccino”, and the system displays the information on the coffee shop in the view image.

### EXAMPLE 7

The application scene in this example is: when a mother says, “I need my family to bring me some cold medicine”, the prompt information processing system may automatically notify her husband and son, and set an unfixed (unspecified specific problem) tag (i.e., a prompt tag), so that the pharmacy may issue an alert and display information about the purchase of the cold medicine. When her family walks through any pharmacy, they will be prompted. When one of the family completes the action, the system database will set the demand for the purchase of the medicine to be completed, and the rest of the family will receive a reminder to cancel the request.

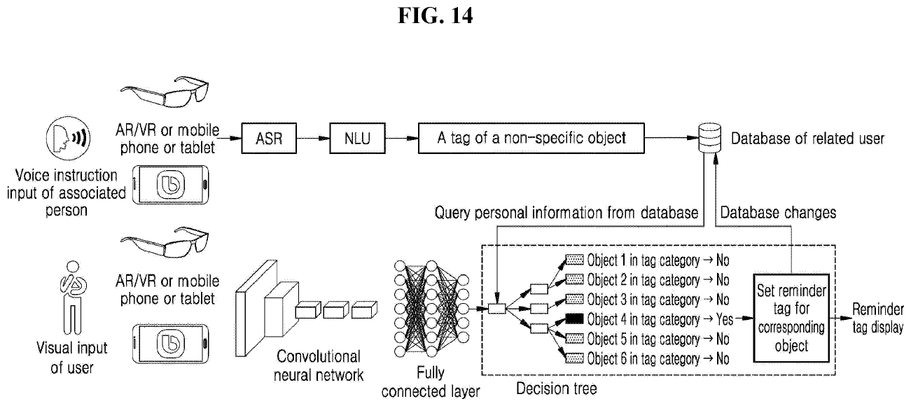

The application scenes in Example 6 and Example 7 need to perform interaction between a plurality of user devices. which requires device networking and multi-user database support. As an alternative solution, FIG. 14 shows a schematic diagram of the operation principle of the system (the prompt information processing system in the present example) for implementing the AR/VR reminding function of the above non-specific object reference.

As shown in FIG. 14, the system may include a device (referred to as a first device) of a user (referred to as a first user) that issues an instruction and a device (referred to as a second device) of a user (referred to as a second user) for which the reminder tag (i.e., the prompt information) is displayed, the first device is connected with the second device by communication. Corresponding to FIG. 14, the first user is the associated person shown in the figure (e.g., the girlfriend shown in Example 6), and the first device is the device of the associated person, which may specifically be an AR/VR device, a mobile phone, a tablet, or other terminal devices of the user; the second user is the person using it shown in the figure (e.g., the boy shown in Example 6), and the second device is the device of the person using it, which may specifically be the AR/VR device, or a mobile phone, a tablet, or other terminal devices having the AR/VR function, of the user. The process for implementing the reminding function based on the system may specifically include:

After the first device receives the voice instruction sent by the first user, the voice instruction is parsed by the ASR module and the NLU module to obtain a speech recognition, and the decision module of the system may generate a tag (i.e., the reminder tag, such as the prompt information of bringing coffee in Example 6) based on a non-specific object (for example, the coffee shop in Example 6) according to the speech recognition result; in addition, the system may also obtain the personal information (for example, the information that the girlfriend likes cappuccino, as shown in the figure) of the user associated with the tag by the database of the associated user. The second device collects the video stream of the second user, and the images in the video stream are recognized by the image recognition module (the convolutional neural network and the fully connected layer shown in the figure in the example) to obtain an image recognition result. The above tag, user personal information, and image recognition result are all input into the decision module (the decision tree shown in the figure) of the system, and the decision network performs comprehensive analysis and judgment based on the information. When an object (e.g., any coffee shop in Example 6) that satisfying conditions of the above non-specific object appears in the images, the object 4 shown in the figure is the object that satisfying conditions, and meanwhile, the decision network may display the reminder tag in the view image of the second user based on this object.

It should be noted that, in practical applications, various functional parts (ASR module, NLU module, image recognition module, decision network, etc.) of the system shown in the figure may be deployed on one or more devices, for example, the first device, the second device, the server, and the like.

### EXAMPLE 8

Based on the solution provided by the embodiment of the present disclosure, the present example implements an AR/VR reminding function that binds a specific object and updates as the position of the object changes to solve the problem of how to update the prompt tag after the object is moved. In this solution of the example, the object recognition and action recognition function of the processing system in the embodiment of the present disclosure is used to bind the tag to the object, so that the tag is updated as the position of the object changes.

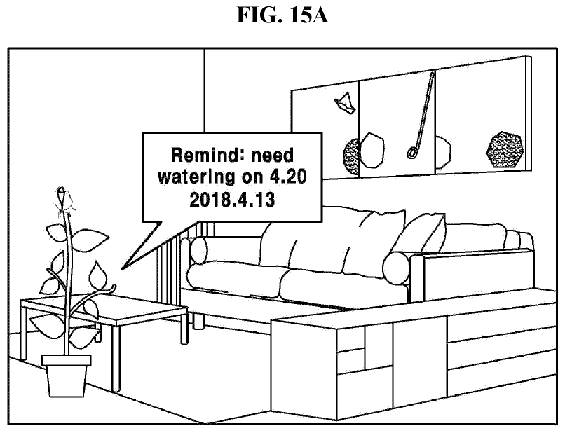

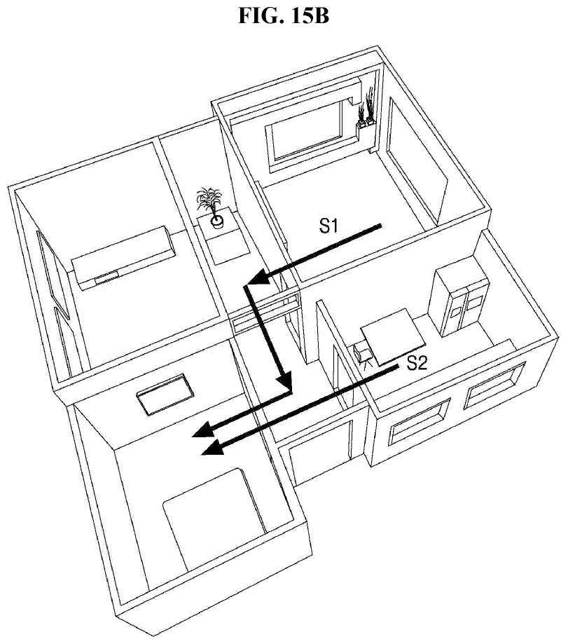

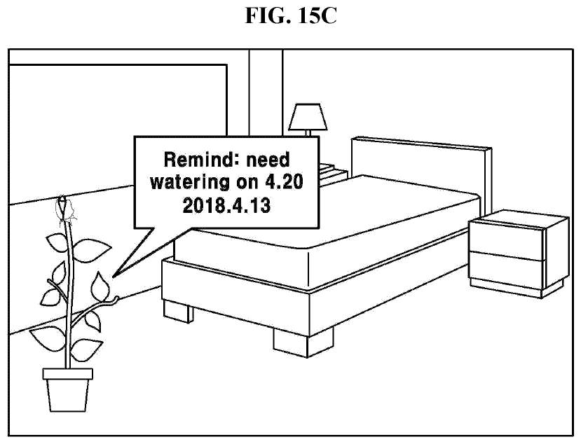

A schematic diagram of an application scene in this example is shown in FIG. 15A. As shown in the figure, the user issues an instruction of “remind me to water the plants next week”, and after obtaining the user instruction, the system performs analysis on the environment in which the user is located by analyzing the user view image, and recognizes that the object in the scene is the “plant”. Based on the recognition result for the user instruction and the recognition result for the user view image, the system obtains the prompt information shown in the figure: “remind: need watering on 4.20, 2018.4.13”, the time “2018.4.13” in the prompt information is the time when the system receives the user instruction, and the time “4.20” is the time when the user wants to perform the watering action. The prompt information and the plant in the current view image of the user may be displayed together by the AR/VR device (when the VR device is used, the VR scene may be a scene modeled based on the actual scene in which the user is located) of the user.

In one case, when the user moves the object while using the AR/VR device, the system may first use the image recognition module to recognize whether the object is an object with a reminder tag, and if the object is recognized as the object with the reminder tag, then the system may recognize the user's moving action by recognizing the user view image. As shown in FIG. 15B, it is assumed that the user moves the plant from the starting position of the path to the end position of the path along the path Si shown in the figure. After the user action is completed, the system may obtain the user's current view image by the user's AR/VR device. It is assumed that the user moves the plant along the path Si from the living room shown in FIG. 15A to the bedroom shown in FIG. 15C. At this time, the system recognizes the current view image as shown in FIG. 15C. Specifically, as an alternative manner, the system may extract local features (such as corner features) of the region where the plants are located in the image shown in FIG. 15A, and find the plants in the image shown in FIG. 15C based on these local features, that is, performing object (the plant in this example) tracking on the two images of FIGS. 15A and 15C based on these local features. After recognizing the plant in FIG. 15C, the system updates the position attribute of the reminder tag that is bound to the object, and displays the reminder tag together with the plant in FIG. 15C, as shown in FIG. 15C.

In addition, after the setting of the reminder tag is completed, if the user's position has moved (for example, the user going out), the current view image of the user at this time is likely to have no such plant, and then the virtual reminder tag may not be rendered. In addition, if the user returns home, as shown in FIG. 15B, assuming that the user moves along the path S2 shown in the figure after returning home, the plant appears again in the user view, at this time the user's current view image may be recognized again to find the plant, or based on the obtained identification information (for example, the above local features) of the object in the historical image, the plant is recognized in the current view image; the prompt information is displayed in the current view image of the user based on the plant.

In addition, when the execution time of the user item corresponding to the reminder tag arrives, as in the example, when the current date is 4.20, if the plant does not exist in the user's view image, then at this time, the guidance information may be generated for the user based on a relative positional relationship between the objects at the user's home of the historical record and the objects in the user's current view image, so that the user may move based on the guidance information, thereby the plants appearing in the user view, or the prompt information may be sent to other terminal devices of the user.

In other words, when the user needs to find an object, the system may automatically plan a search path according to the position information recorded for the object, and guide the user to find the object to be found.

In another case (when the user does not use the AR/VR device, if the user moves the object (the plant in this example, or when someone else moves the object, the system cannot sense the movement for the object), when the user uses the AR/VR device again, the system learns from the image recognition result that the object with similar features detected in the new environment has been marked for reminding before; since it cannot be excluded that two obj ects with similar shapes exits, when encountering this case, the system may query the user whether it is a new object, or a previous object that has been moved. If the user informs that the position of the previous object has been moved, the position attribute of the original reminder tag may be updated, and if it is another object with similar or identical appearance, the system may be marked here to avoid repeated questions.

### EXAMPLE 9

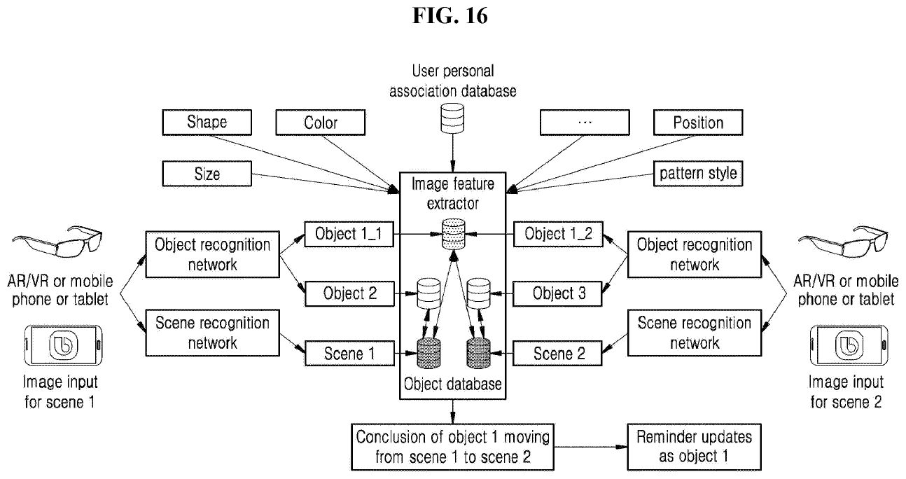

For the case that the position of the object associated with the reminder tag moves, FIG. 16 is a schematic diagram showing the workflow of the prompt information processing system provided by the embodiment of the present disclosure.

As shown in FIG. 16, in this example, the image recognition module of the system may include an object recognition network, a scene recognition network, and an image feature extractor. For the scene 1 (for example, the scene shown in FIG. 15A), the view image (the image input of the scene 1 shown in the figure) may be obtained by the user's AR/VR device, a mobile phone, a tablet or the like, the image is input to the object recognition network and the scene recognition network respectively; the object recognition network recognizes the objects in the scene, such as the objects 1_1 and 2 shown in the figure. In this example, the object 1 is an object associated with the prompt information (i.e., the object displaying the reminder tag, such as the plant in Example 8), and the object 2 may be saved to the object database (part of the database module). The scene recognition network recognizes that the current scene is the scene 1, and stores relevant information of the scene 1 in the scene database (a database for storing scene information in the database module). When the user view changes, it is assumed that the changed scene is scene 2 (the scene as shown in FIG. 15C), and the user view image (the image input of scene 2 shown in the figure) in scene 2 is input to the object recognition network and the scene recognition network respectively; the object recognition network recognizes the objects in the scene, for example, the object 1_2 and the object 3 shown in the figure, and the scene recognition network recognizes that the current scene is the scene 2, and also stores the relevant information of the scene 2 in the scene database.

In this example, the image feature extractor is used to extract features of the recognized objects so that the objects may be confirmed based on these features as being identical or the same object. Features extracted by the feature extractor may include, but is not limited to, size, shape, color, pattern style, position information, etc. of the object, and the algorithm may recognize the object again by the comparison of the information. For example, for the object 1_1 and object 2 recognized in the scene 1, the image feature extractor may extract and record the features of the two objects, respectively, and for the object 1_2 and object 3 recognized in the scene 2, the same algorithm may perform feature extraction and object recognition on the two objects. Then, in the process of feature comparison, the algorithm finds that the object 1_1 in the scene 1 and the object 1_2 in the scene 2 are consistent in features such as shape, size, color, and pattern style, but the marked position information is inconsistent, and the algorithm finally determines that the object 1_1 and the object 1_2 are the same object, so that both the object 1_1 and the object 1_2 are collectively recognized as the object 1 in the figure, and the conclusion that the object 1 is moved from the scene 1 to the scene 2 is obtained. The features of all recognized objects are stored in the object feature database in accordance with the united formatting information. The user's personal association database stores the associated information of the object and the user, the information is associated with the object feature database, and may be used together for object recognition and behavioral habit analysis service of the user.

The embodiment of the present disclosure provides an AR/VR based reminding system, and implements the AR/VR based reminding function. Based on the solution in the embodiment of the present disclosure, it may not only facilitate the user to establish a reminder, but also interact with other mobile phone, tablet and other terminals through the network. The mobile phone, tablet or other terminals may obtain a frame of the image in the user AR/VR scene, and the tag is marked in the image, where the marked information is transmitted in real-time or transmitted at one time after completing the editing, to the user of the AR/VR, to realize information sharing. At this time, the user's mark information and/or editing information on the image may be used as the prompt information.

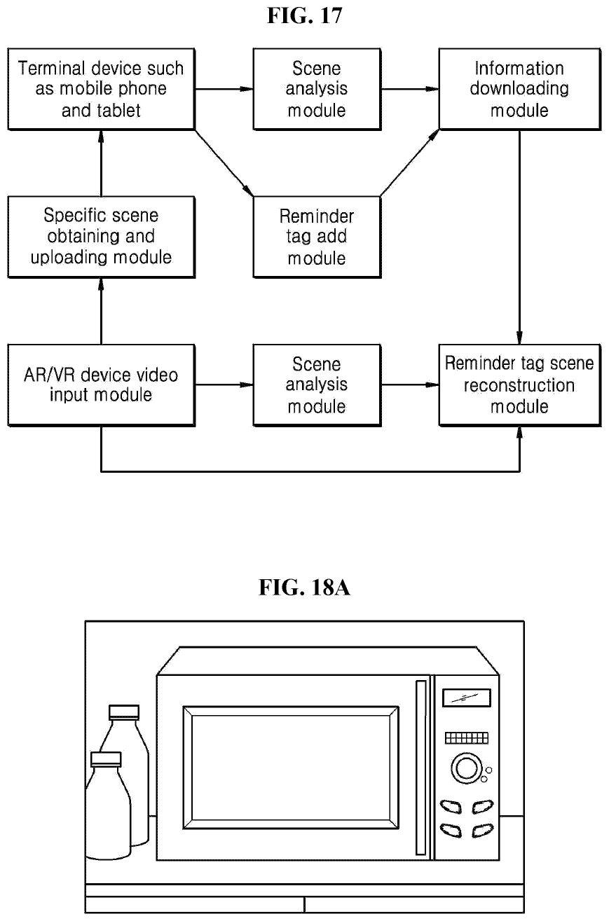

FIG. 17 is a schematic structural diagram of the prompt information processing system (may be simply referred to as an AR/VR reminding system) provided in the present example, and the detailed description of each part shown in the figure is as follows:

1. The video input module of the AR/VR device is used to obtain the video information (that is, the image) of the AR/VR device in real time;

2. The specific scene obtaining and uploading module, that is, the module that manually or voice-triggered or automatically intercepts a frame image in the scene and uploads it to a terminal such as a mobile phone or tablet;

3. The terminal device such as a mobile phone and tablet receives the scene image, and may use the smart voice assistant or handwriting or other tools to directly establish a virtual reminder tag on the image;

4. For the scene analysis module, the module is part of the image recognition module and exists on the terminal devices such as the AR/VR device, mobile phone and tablet, mainly analyzing the object information in the scene, and performing image segmentation on the objects in the scene, which is more convenient to the reminder tag add module to add a reminder tag to the accurate position in the image; the scene analyzing module also collects the corner features (that is, the image features) in the scene, wherein the common corner features include scale-invariant feature transform (SIFT) features, Speeded Up Robust Features (SURF), FAST corner features, binary robust invariant scalable keypoint (BRISK) features and the like, and these corner features may help to map images received by terminals such as mobile phone or tablet to actual AR/VR scenes, which are an indispensable part;

5. The information downloading module returns the result of the scene analysis module and the added tag information to the AR/VR device;

6. The reminder tag scene reconstruction module performs matching analysis on the information returned from the terminal device such as the mobile phone or tablet with the actual scene video of the AR/VR, and reconstructs the reminder tag in the AR/VR scene.

The following describes the prompt information processing method in the information sharing scene in combination with two specific examples.

### EXAMPLE 10

In this example, a scene in which a mother seeks help from his son while using a microwave oven is taken as an example.

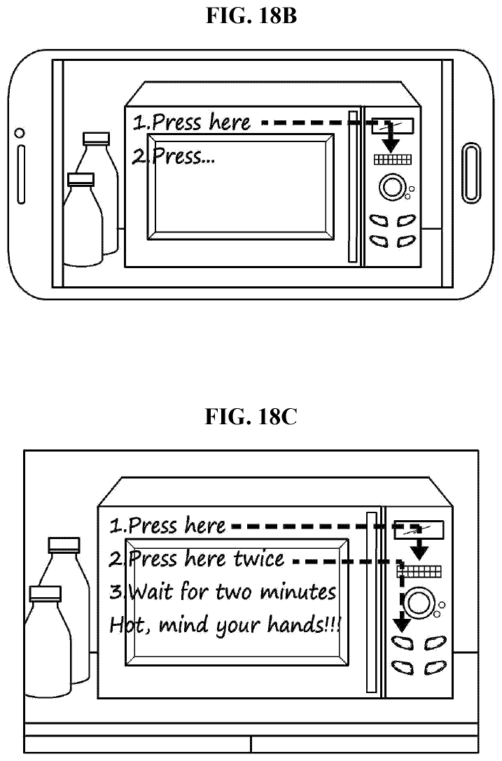

The view image of the mother in this example is shown in FIG. 18A. The mother does not know how to use the microwave oven, and takes a photo of a microwave oven shown in

FIG. 18A and sends it to her son for help. After her son's mobile phone receives this photo, he may edit the photo displayed on the phone and write a messages, as shown in FIG. 18B; her son may edit the text on the photo and mark it (the arrow shown in the picture). By the solution of the embodiment of the present disclosure, the mother may see the use tutorial (that is, the above-mentioned text and marks) of the microwave oven marked by her son through the AR device, as shown in FIG. 18C.

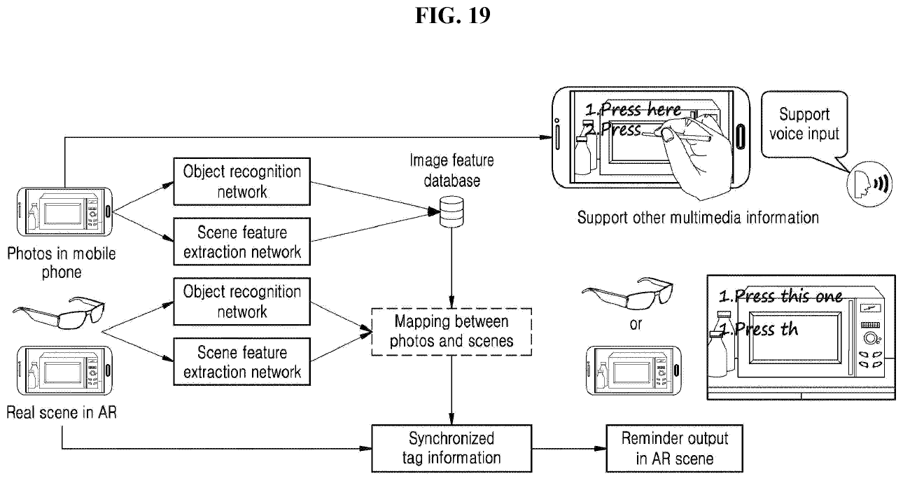

FIG. 19 is a schematic diagram showing the operation principle of a system for implementing the above information sharing solution. As shown in the figure, the mobile phone on the upper left side of the figure is the son's mobile phone, and the mobile phone and AR glasses on the lower left side (certainly, these two devices may also be a device with AR and photo shooting functions) are the terminal devices of the mother. For the son's side, after the mobile phone receives the photo shown in FIG. 18A, the photo may be edited by handwriting or voice or other means (the part supporting the multimedia information shown in the upper right corner of the figure). For the edited image, the object recognition network of the scene analysis module recognizes the edited image, recognizes that the object in the image is the microwave oven, and the scene feature extraction network of the scene analysis module extracts the corner features in the edited image. After that, the system may obtain the view image of the mother at this time, recognize the view image through the object recognition network, and extract the corner features in the view image through the scene feature extraction network, and perform feature matching of the local corner feature extracted from the edited image and the local corner feature extracted from the view image, and determine the mapping between the position information of the edit information in the edited image (i.e., the mark information shown in the figure) and the corresponding position in the current view image, that is, the mapping between the edited image and the view image (the mapping between the photo and the scene shown in the figure); based on the mapping relationship, the edit information may be synchronized to the current view image of the mother, that is, the editing information (the prompt output in the AR scene shown in the figure) of the son may be synchronously displayed in the current view image of the mother, thereby realizing the display of the prompt information associated with the object (the microwave oven in this example) in the AR scene. The edit information in this example is the reminder information.

In this kind of application scene, since the glasses is likely moved as the person wearing it moves, it is necessary to determine the same object in different images by means of image matching. In addition, in practical applications, after the above matching is completed, the tracking of the object may be implemented based on the object tracking algorithm, so that the resource consumption is relatively small. Meanwhile, it is necessary to periodically make matching calibration errors. In addition, the scene database shown in the figure stores data of the current scene, and may also save the data of the previous scene, so that after the user is reminded of the content once, if the user's view enters the scene again, the user may be reminded in next time when seeing it.

### EXAMPLE 11

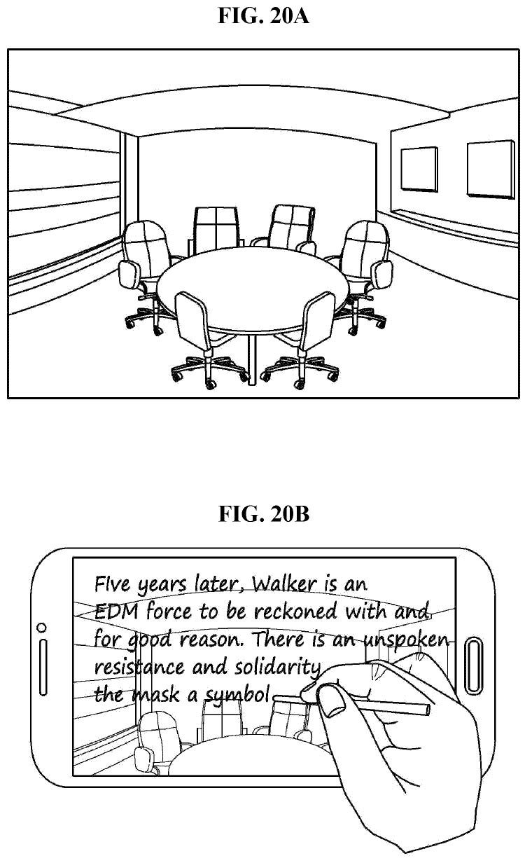

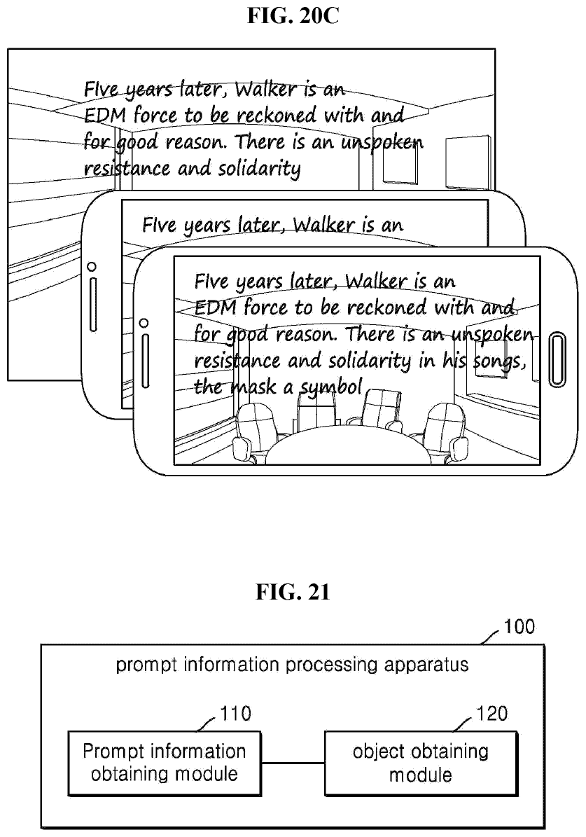

The application scene in which a multi-person conference shares notes is shown in this example. As shown in FIG. 20A, which is a schematic diagram of a conference room scene, when multiple conference participants capture images of the same scene, the system provided by the embodiment of the present disclosure may share notes of the multi-person conference.

Specifically, the participants of the conference may first take photos of the white wall of the conference room (certainly, may be other areas). During the conference, when a conference participant writes a meeting minutes or other notes on the photo taken by himself, as shown in FIG. 20B, these meeting minutes or notes may be used as prompt information (that is, information that needs to be shared). Based on the information sharing function provided by the embodiment of the present disclosure, these meeting minutes or notes may be displayed to other photos taken by the other conference participants, other authorized conference participants may obtain the content marked by other users in the same scene, as shown in FIG. 20C. Certainly, other later conference participants may also obtain the shared information by capturing the same scene. The specific implementation of multi-person information sharing in this example may refer to the above description in Example 10.

In one embodiment, a prompt information processing apparatus may include a memory configured to store one or more instructions, and at least one processor configured to execute the one or more instructions stored in the memory to obtain prompt information, and obtain an object to output the prompt information based on the object.

In one embodiment, the prompt information and the object are obtained by obtaining and analyzing a user voice instruction, obtaining and analyzing a user view image, and determining the prompt information and the object based on a result of the user voice instruction analysis and a result of the user view image analysis.

In one embodiment, the at least one processor is further configured to analyze the user view image based on the user voice instruction.

In one embodiment, the at least one processor is further configured to determine an image analysis algorithm based on the user voice instruction, and analyze the user view image based on the determined image analysis algorithm.

In one embodiment, the at least one processor is further configured to analyze the user voice instruction based on a preliminary result of the user view image analysis, and analyze the user view image based on a preliminary result of the user voice instruction analysis.

In one embodiment, the object are obtained by determining a plurality of selectable object options for the prompt information based on the result of the user voice instruction analysis and the result of the user view image analysis; and obtaining the object based on user's choice from the plurality of selectable object options.

In one embodiment, the object are obtained by determining the object in the user view image based on object indication information carried in the user voice.

In one embodiment, the object are obtained by obtaining and analyzing a user voice instruction, determining the prompt information based on a result of the user voice instruction analysis, determining whether object indication information is carried in the user voice instruction, and on determining that the object indication information is not carried in the user voice instruction, automatically determining the object based on the result of the user voice instruction analysis.

The automatically determined object may be a non-specific object.

In one embodiment, the at least one processor is further configured to when position information of the object changes, displaying the prompt information in a user view image according to the changed position information of the object.

In one embodiment, the prompt information and the object are obtained by obtaining a historical image of a user, recognizing a user behavior based on the historical image, and automatically generating the prompt information according to the user behavior.

In one embodiment, the prompt information and the object are obtained by obtaining a photo, displaying the photo, obtaining user input associated with the displayed photo, and determining the prompt information and the object by analyzing the user input associated with the displayed photo.

The photo may be obtained by the current device or from another device.

In one embodiment, the prompt information is obtained by receiving the prompt information from another device, and the at least one processor is further configured to display the prompt information in a user view image based on the object.

The object may be received from the other device.

In one embodiment, the object are obtained by obtaining information sent by the other device that can be used for determining the object, and determining the object in the user view image based on the received information that can be used for determining the object.

The information sent by the other device that can be used for determining the object may be a non-specific reference.

In one embodiment, the prompt information is obtained by receiving the prompt information from another device, and the at least one processor is further configured to display the prompt information in a photo based on the mapping relationship between the photo and a user view image.

The object may be received from the other device.

In another embodiment, a prompt information processing method is provided. The method may include obtaining prompt information, and obtaining an object to output the prompt information based on the object.

This application proposes a system that combines the image recognition technology in the AI field with the automatic speech recognition and natural language understanding technology for the scene of the user using the AR/VR, thereby providing the user with an service that intelligently establishing and using reminder item based on AR/VR. The solutions provided by embodiments of the present disclosure achieve the following:

1. For the problem that the existing presentation manner of the reminding items is limited, the embodiment of the present disclosure proposes a solution for generating a reminding item by using multimedia information, which is capable of displaying a reminder item through the multimedia information, wherein the multimedia information includes text, image, sound, video, and super links, hypertext, etc.;

2. By using AR/VR devices to generate reminder items in real-time scenes/virtual scenes, in addition to being more intuitive and convenient, the defect of using the text to record the reminder items on the mobile phone which is complicated and is not simple and intuitive is solved by reasonably controlling the time when these reminder items appear, the geographical position where these reminder items appear and the form of presentation, etc.;

3. Due to the difference of the voice instructions, according to the results of the automatic speech recognition and natural language understanding module, the image recognition module can dynamically adjust the recognized tasks in the recognition phase, thereby reducing the resource consumption while accurately recognizing the object;

4. The recognition result of the image recognition module is combined with the result recognized by the automatic speech recognition and natural language understanding module to more accurately determine the user intent;

5. The system may analyze the user's non-standard voice instructions or another name of the objects or events used by the user according to the scene and the user's usage, which is recorded in the database associated with the user; in actual use, the system may correct the recognized results according to the information in the database, thereby assisting the system to accurately understand the user intent and make a correct feedback;

6. The use of visual and audio multi-modal information input, provides more rich information according to the current scene, which may automatically determine the potential requirements of user and automatically establish reminder items in some scenes;

7. It may recognize the special attributes of some objects, and add these attributes to the user's action judgment, of which the purpose is to be able to judge the user's actions more accurately and automatically generate reminder items; for example, the image recognition module recognizes that the user has taken one medicine vial, and it is easy to judge that the user regularly takes medicine for himself or the people around him regularly takes medicine, and according to this information, a reminder for regular medication and a reminder of the placement of the medicine may be generated;

8. The historical image recognition result and speech understanding result of the user may be saved, to excavate an action conforming to the user's own behavior, so that the system may set different action recognition systems for different user habits;

9. By using image recognition technology and natural language understanding technology, it is possible to realize an one-to-many binding relationship between the virtual reminder tag and the object in the actual scene;

10. Benefited from the combination of the two parts of the recognition of the user's action and the recognition of the object, it is easy to judge that the user moves the same object from one scene to another scene, so that the tag information can update the position information as the movement of the object;

11. In addition to image recognition technology, the system records the user's position, preferences and other information to confirm the user's real requirements for the marked object, and make a query when a computer cannot judge, for example, when the user faces multiple photos on the wall and gives an reminder item “dinner at tomorrow night”, the user may add a visual tag to the right side of the photo centered on the right side according to the user's habits;

12. The picture of the user scene on the mobile phone or tablet may be opened, and an electronic tag is established on the picture by means of stylus, voice or keyboard input, and the electronic tag is transmitted to another AR/VR device in real-time or transmitted to the another AR/VR device at one time after the tag is created; (this function may well remotely guide the family to complete operations of some household appliances, and may also have a function of leaving the family a message and other functions).

Based on the same principle as the method shown in FIG. 1, the embodiment of the present disclosure also provides a prompt information processing apparatus. As shown in FIG. 21, the prompt information processing apparatus 100 may include a prompt information obtaining module 110 and an object obtaining module 120.

The prompt information obtaining module 110 is configured to obtain prompt information;

the object obtaining module 120 is configured to obtain an object in a user view image to output the prompt information based on the object.

Alternatively, the object may be determined by at least one of the following manners:

determining by performing image recognition on the user view image;

determining according to object data in the user view image.

Alternatively, the prompt information may be obtained by at least one of the following manners:

prompt information obtained by a user instruction;

prompt information sent by another device;

prompt information automatically generated according to a user intent;

prompt information generated based on a preset manner.

Alternatively, the object may be determined according to at least one of the following information:

object indication information carried in a user instruction;

a user's focus point in the user view image;

personalized information of the user;

a historical behavior of the user for the object;

information sent by another device that may be used for determining the object;

Alternatively, the object indication information includes the attribute information of the object, wherein the object is obtained by at least one of the following manners:

determining an image recognition algorithm according to the attribute information of the object and/or a scene in which the user is located; performing the recognition on the user view image according to the determined image recognition algorithm to recognize the object.

Alternatively, the apparatus may further include an information display module, and the module is configured to:

display the prompt information in the user view image based on the object.

Alternatively, the information display module is further configured to: when position information of the object changes, display the prompt information in the user view image according to the changed position information of the object.

Alternatively, the apparatus may further include a prompt information reprocessing module, wherein the module is configured to perform at least one of the following steps:

generating guidance information of the object to locate the object in the user view image based on the guidance information;

displaying the prompt information in the user view image;

sending the prompt information to another device to display the prompt information to the user through the another device.

The embodiment of the present disclosure further provides an electronic device, including a processor and a memory; wherein the memory stores machine readable instructions; the processor is configured to execute the machine readable instructions to implement the method provided in any of the embodiments of the present disclosure.

Alternatively, the electronic device may include an AR device or a VR device.

The embodiment of the present disclosure also provides a computer readable storage medium, wherein the readable storage medium stores a computer program, the computer program being executed by a processor to implement the method provided by any of the embodiments of the present disclosure.

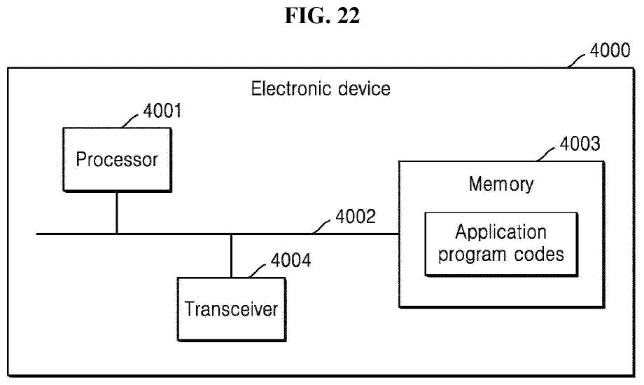

As an example, FIG. 22 shows a schematic structural diagram of an electronic device 4000 suitable for the solution of the embodiment in the present disclosure, and as shown in FIG. 22, the electronic device 4000 may include a processor 4001 and a memory 4003. Wherein, the processor 4001 is connected to the memory 4003, for example, through the bus 4002. Alternatively, the electronic device 4000 may further include a transceiver 4004. It should be noted that, in practical applications, the number of the transceiver 4004 is not limited to one, and the structure of the electronic device 4000 does not constitute a limitation on the embodiments of the present disclosure.

The processor 4001 may be a Central Processing Unit (CPU), a general-purpose processor, a Digital Signal Processor (DSP), an Application Specific Integrated Circuit (ASIC), and a Field Programmable Gate Array (FPGA) or other programmable logic devices, transistor logic devices, hardware components, or any combination thereof. It is possible to implement or carry out the various illustrative logical blocks, modules and circuits described in connection with the present disclosure. The processor 4001 may also be a combination of computing functions, such as one or more microprocessor combinations, a combination of a DSP and a microprocessor, and the like.

The bus 4002 may include a path for communicating information between the above components. The bus 4002 may be a Peripheral Component Interconnect (PCI) bus or an Extended Industry Standard Architecture (EISA) bus. The bus 4002 may be divided into an address bus, a data bus, a control bus, and the like. For convenience of representation, only one thick line in FIG. 22 is used to represent the bus, but it does not mean that there is only one bus or one type of bus.

The memory 4003 may be a Read Only Memory (ROM) or other type of static storage device that may store static information and instructions, Random Access Memory (RAM) or other types of dynamic storage device that may store information and instruction, may also be Electrically Erasable Programmable Read Only Memory (EEPROM), Compact Disc Read Only Memory (CD-ROM) or other optical disc storage, a disc storage (including compression optical discs, laser discs, optical discs, digital versatile discs, Blu-ray discs, etc.), magnetic disk storage medium or other magnetic storage devices, or any other medium that may be used to carry or store desired program codes in form of instruction or data structure and may be accessed by the computer, which is not limited to these.

The memory 4003 is used to store application program codes for executing the solution of the present disclosure, and is controlled by the processor 4001 for execution. The processor 4001 is configured to execute the application program codes stored in the memory 4003 to implement the solution shown in any of the foregoing method embodiments.

It should be understood that although the various steps in the flowchart of the drawings are sequentially displayed as indicated by the arrows, these steps are not necessarily performed in the order indicated by the arrows. Except as explicitly stated herein, the execution of these steps is not strictly limited sequentially, and may be performed in other orders. Moreover, at least some of the steps in the flowchart of the drawings may include a plurality of sub-steps or stages, which are not necessarily performed at the same time, but may be executed at different times, and the execution order thereof does not need to be performed sequentially, but may be performed alternately or alternately with at least a portion of other steps or sub-steps or stages of other steps.

The above is only a part of the embodiments of the present disclosure, and it should be noted that those skilled in the art may also make several improvements and retouchings without departing from the principles of the present disclosure. It should be considered as the scope of protection of the present disclosure.

1. A prompt information processing apparatus, comprising:
a memory configured to store one or more instructions; and
at least one processor configured to execute the one or more instructions stored in the memory to:
obtain prompt information, and
obtain an object to output the prompt information based on the object.

2. The prompt information processing apparatus of claim 1, wherein the prompt information and the object are obtained by:
obtaining and analyzing a user voice instruction,
obtaining and analyzing a user view image, and
determining the prompt information and the object based on a result of the user voice instruction analysis and a result of the user view image analysis.

3. The prompt information processing apparatus according to claim 2, wherein the at least one processor is further configured to:
determine an image analysis algorithm based on the user voice instruction, and
analyze the user view image based on the determined image analysis algorithm.

4. The prompt information processing apparatus according to claim 2, wherein the at least one processor is further configured to:
analyze the user voice instruction based on a preliminary result of the user view image analysis, and
analyze the user view image based on a preliminary result of the user voice instruction analysis.

5. The prompt information processing apparatus according to claim 2, wherein the object are obtained by:
determining a plurality of selectable object options for the prompt information based on the result of the user voice instruction analysis and the result of the user view image analysis; and
obtaining the object based on user's choice from the plurality of selectable object options.

6. The prompt information processing apparatus according to claim 2, wherein the object are obtained by:
determining the object in the user view image based on object indication information carried in the user voice.

7. The prompt information processing apparatus of claim 1, wherein the object are obtained by:
obtaining and analyzing a user voice instruction,
determining the prompt information based on a result of the user voice instruction analysis,
determining whether object indication information is carried in the user voice instruction, and
on determining that the object indication information is not carried in the user voice instruction, automatically determining the object based on the result of the user voice instruction analysis.

8. The prompt information processing apparatus of claim 1, wherein the at least one processor is further configured to:
when position information of the object changes, displaying the prompt information in a user view image according to the changed position information of the object.

9. The prompt information processing apparatus of claim 1, wherein the prompt information and the object are obtained by:
obtaining a historical image of a user,
recognizing a user behavior based on the historical image, and
automatically generating the prompt information according to the user behavior.

10. The prompt information processing apparatus of claim 1, wherein the prompt information and the object are obtained by:
obtaining a photo,
displaying the photo,
obtaining user input associated with the displayed photo, and
determining the prompt information and the object by analyzing the user input associated with the displayed photo.

11. The prompt information processing apparatus of claim 1, wherein
the prompt information is obtained by receiving the prompt information from another device, and
the at least one processor is further configured to display the prompt information in a user view image based on the object.

12. The prompt information processing apparatus of claim 11, wherein the object are obtained by:
obtaining information sent by the other device that can be used for determining the object, and
determining the object in the user view image based on the received information that can be used for determining the object.

13. The prompt information processing apparatus of claim 1, wherein
the prompt information is obtained by receiving the prompt information from another device, and
the at least one processor is further configured to display the prompt information in a photo based on the mapping relationship between the photo and a user view image.

14. A prompt information processing method, comprising:
obtaining prompt information; and
obtaining an object to output the prompt information based on the object.

15. A computer readable storage medium, wherein the readable storage medium stores a computer program, the computer program being executed by a processor to implement the method of claim 14.
